(19) United States
(12) Patent Application Publication
(10) Pub. No.: US 2017/0032092 A1
(43) Pub. Date: Feb. 2, 2017

(54) Real Time Multispecialty Telehealth Interactive Patient Wellness Portal (IPWP)

(71) Applicants: Benjamin Franklin Mink, Morrow, OH (US); Kelly Marie Mink, Corinth, KY (US)

(72) Inventors: Benjamin Franklin Mink, Morrow, OH (US); Kelly Marie Mink, Corinth, KY (US)

(21) Appl. No.: 15/184,208

(22) Filed: Jun. 16, 2016

(51) Int. Cl. G06F 19/00; G06Q 30/02; G06Q 10/10

(52) U.S. Cl. CPC G06F 19/3418; G06F 19/322; G06F 19/3406; G06F 19/328; G06Q 10/1095; G06Q 30/0241; G06F 19/3456

(57) ABSTRACT

A novel telehealth video conferencing system (process) that is designed to enable the patient user to have a real-time or near real-time 2 way tele-conference/consult including the transfer of patient specific biometric information with a health care provider team (one or more health care providers simultaneously, i.e. a team consisting of a pharmacist, physician, mental health provider, clinical lab, mental health provider, orthopedist, podiatrist, dentist, clinical specialist, etc. . . . ) located remotely from the telehealth digital/video patient user portal. The present invention, the IPWP is an interactive-digital health care provider network to patient portal designed to provide patients with the same level of quality care that they would expect to receive if they were physically in a multispecialty doctor or health care providers' (nurse practitioner, physician assistant, dentist, ophthalmologist, orthopedist, podiatrist, medical specialty clinic, hospital, etc. . . . ) office. However, the patients that utilize the IPWP will interact with their health care provider/s on a computer/notebook/smart device screen/monitor via existing secure digital web or cellular camera technology in a mobile or stationary, enclosed/private HIPP compliant environment at a retail pharmacy or a pharmacy supported location (workplace, educational facilities, retail stores, etc. . . . that have an in-house, adjacent or an electronic dispensing pharmacy). Current statistics demonstrate that 80% of primary care provider visits result in the health care provider writing a script for medication. Medication management is critical to safe, effective quality care and has been an issue of health care reforms Accountable Care Organization concept since 2009. In order for the patient to receive comparable care to what they would receive in a multispecialty provider/doctor's office with an onsite pharmacy, the IMP will combine the use of existing biometric sensor technologies (i.e. Strain Gauge Tech, IR Thermometer, etc.) in order for the system to take patient real time biometric information such as height, weight, blood pressure, pulse, EKG, blood glucose, body temperature, etc. . . . as well as identify the patient positively by both video capture and biometric scanning (fingerprint, iris scan, driver's license photo, etc. . . . ). It also has the capability to upload information from certain glucose readers in order for the physician to better assess a patient's blood sugar levels and may incorporate the use of magnified micro camera technology and lighting to look at a patient's microanatomy (ear canals, nasal passages, skin conditions, color and eye examination, etc. . . . ). In addition to the use of sensor technology the IPWP can incorporate the use of antimicrobial materials or technologies (copper ions, silver ions, UV light, HEPA filters, etc. . . . ) to reduce the communication of disease from patient to patient. The monitor, web camera, and other vital components will be designed to be permanently or temporarily (mobile system) located within a secure/private enclosure at a pharmacy or pharmacy supported location (private kiosk, room, booth, enclosure, space, etc. . . . ). All patient information and electronic forms will be transmitted via a secure encrypted web based digital or cellular portal to multiple providers as needed simultaneously for a seamless 3-way (or more) consultation/communication. The IPWP will be linked to a smartphone/computer/Internet/web app that will allow the patient to view availability and schedule appointments at their local pharmacies IPWP or alternatively on a walk-in, as needed basis. Lastly, the unit will be equipped with electronic payment technologies such as card (swipe) readers, etc. . . . to capture/collect payment from credit cards, PayPal and debit cards for all health care services provided including, but limited to co-pays, payments, prescriptions, lab test, etc. . . . .

In summary the ability of the patient portal system to provide real time, multiple simultaneously communicating health care providers with real time biometric information (including the onsite or tele pharmacist) is a novel process not limited to the single provider video/audio access currently patented. This new dimension to telehealth promises a telehealth experience that at a minimum matches the diagnostics ability and access of a multispecialty clinic or traditional hospital setting while exceeding the clinical/diagnostic ability of a single health care provider's office or clinic that is more accessible at a 50% reduced cost and resulting in better health outcomes.

### RELATED APPLICATIONS

This application is a continuation-in-part of pending U.S. patent Application No. 62/390,649, filed on Apr. 6, 2016. The contents of the above application are all incorporated herein by reference.

### PRIOR ART REFERENCES CITED

### Referenced by

### U.S. Patent Documents

| | | |
|---|---|---|
| 4,884,514 | December 1989 | Shockey et al. |
| 5,036,779 | August 1991 | Capraro |
| D334985 | April 1993 | D'Agostino et al. |
| D344140 | February 1994 | Webster |
| 5,393,964 | February 1995 | Hamilton et al. |
| 5,441,047 | August 1995 | David et al. |
| 5,544,649 | August 1996 | David et al. |
| 5,558,638 | September 1996 | Evers et al. |
| 5,619,991 | April 1997 | Sloane |
| 5,646,605 | July 1997 | Leonaggeo et al. |
| 5,660,176 | August 1997 | Iliff |
| 5,727,353 | March 1998 | Getz et al. |
| 5,801,755 | September 1998 | Echerer |
| 5,810,747 | September 1998 | Brudny et al. |
| 5,868,669 | February 1999 | Iliff |
| 5,897,493 | April 1999 | Brown |
| 5,910,107 | June 1999 | Iliff |
| 5,987,519 | November 1999 | Peifer et al. |
| 5,997,476 | December 1999 | Brown |
| 6,007,459 | December 1999 | Burges |
| 6,022,315 | February 2000 | Iliff |
| 6,046,761 | April 2000 | Echerer |
| 6,071,236 | June 2000 | Iliff |
| 6,101,478 | August 2000 | Brown |
| 6,113,540 | September 2000 | Iliff |
| 6,205,716 | March 2001 | Peltz |
| 6,206,829 | March 2001 | Iliff |
| 6,224,548 | May 2001 | Gopinathan et al. |
| 6,248,064 | June 2001 | Gopinathan et al. |
| 6,248,065 | June 2001 | Brown |
| 6,270,455 | August 2001 | Brown |
| 6,295,767 | October 2001 | Barnhill et al. |
| 6,302,844 | October 2001 | Walker et al. |
| 6,368,273 | April 2002 | Brown |
| 6,369,847 | April 2002 | James et al. |
| 6,381,577 | April 2002 | Brown |
| 6,403,897 | June 2002 | Bluth et al. |
| 6,428,124 | August 2002 | Bluth et al. |
| 6,449,001 | September 2002 | Levy et al. |
| 6,511,435 | January 2003 | Bluth et al. |
| 6,540,673 | April 2003 | Gopinathan et al. |
| 6,594,607 | July 2003 | Lavery |
| 6,595,918 | July 2003 | Gopinathan et al. |
| 6,638,218 | October 2003 | Bulat |
| 6,641,532 | November 2003 | Iliff |
| 6,668,375 | December 2003 | Leovac |
| 6,692,436 | February 2004 | Bluth et al. |
| 6,725,209 | April 2004 | Iliff |
| 6,731,324 | May 2004 | Levy |
| 6,748,353 | June 2004 | Iliff |
| 6,790,178 | September 2004 | Mault et at. |
| 6,850,889 | February 2005 | Zayas, Jr. |
| 6,968,375 | November 2005 | Brown |
| 7,011,629 | March 2006 | Bulat |
| D521155 | May 2006 | Shipard |
| D526065 | August 2006 | Shipard |
| 7,112,175 | September 2006 | Gopinathan et al. |
| 7,188,151 | March 2007 | Kumar et al. |
| 7,223,236 | May 2007 | Brown |
| 7,252,636 | August 2007 | Brown |
| 7,297,109 | November 2007 | Brown |
| 7,297,111 | November 2007 | Iliff |
| 7,300,402 | November 2007 | Iliff |
| 7,310,668 | December 2007 | Brown |
| 7,320,030 | January 2008 | Brown |
| D577127 | September 2008 | Ronco |
| 7,435,222 | October 2008 | Gopinathan et al. |
| 7,516,192 | April 2009 | Brown |
| 7,533,171 | May 2009 | Brown |
| 7,587,469 | September 2009 | Brown |
| 7,613,620 | November 2009 | Salwan |
| 7,624,028 | November 2009 | Brown |
| 7,691,059 | April 2010 | Bulat |
| 7,707,270 | April 2010 | Brown |
| 7,730,177 | June 2010 | Brown |
| 7,734,718 | June 2010 | Brown |
| 7,753,845 | July 2010 | Gopinathan et al. |
| 7,761,312 | July 2010 | Brown |
| 7,822,625 | October 2010 | Brown |
| 7,831,444 | November 2010 | Brown |
| 7,860,725 | December 2010 | Gopinathan et al. |
| 7,870,249 | January 2011 | Brown |
| 7,877,271 | January 2011 | Brown |
| 7,904,310 | March 2011 | Brown |
| 7,912,733 | March 2011 | Clements et al. |
| RE42288 | April 2011 | Degioanni |
| 7,921,186 | April 2011 | Brown |
| D638551 | May 2011 | Gann |
| 7,941,323 | May 2011 | Brown |
| 7,941,326 | May 2011 | Brown |
| 7,941,327 | May 2011 | Brown |
| 7,949,383 | May 2011 | Cable et al. |
| 7,970,620 | June 2011 | Brown |
| 7,970,633 | June 2011 | Bulat |
| 7,979,284 | July 2011 | Brown |
| 7,987,100 | July 2011 | Brown |
| 8,005,691 | August 2011 | Kumar et al. |
| 8,015,025 | September 2011 | Brown |
| 8,015,138 | September 2011 | Iliff |
| 8,027,809 | September 2011 | Brown |
| 8,078,407 | December 2011 | Brown |
| 8,078,431 | December 2011 | Brown |
| 8,095,340 | January 2012 | Brown |
| 8,096,083 | January 2012 | Ma et al. |
| 8,140,663 | March 2012 | Brown |
| D664667 | July 2012 | Krymov et al. |
| 8,260,630 | September 2012 | Brown |
| 8,285,560 | October 2012 | Gopinathan et al. |
| 8,321,284 | November 2012 | Clements et al. |
| 8,337,409 | December 2012 | Iliff |
| 2001/0011224 | August 2001 | Brown |
| 2003/0028399 | February 2003 | Davis et al. |
| 2003/0088441 | May 2003 | McNerney |
| 2003/0163351 | August 2003 | Brown et al. |
| 2004/0006496 | January 2004 | Nickerson |
| 2004/0019259 | January 2004 | Brown |
| 2004/0019261 | January 2004 | Gopinathan et al. |
| 2004/0019505 | January 2004 | Bowman et al. |
| 2004/0107116 | June 2004 | Brown |
| 2004/0230458 | November 2004 | Takayama et al. |
| 2004/0249778 | December 2004 | Iliff |
| 2005/0228883 | October 2005 | Brown |
| 2005/0256739 | November 2005 | Brown |
| 2006/0010014 | January 2006 | Brown |
| 2006/0069753 | March 2006 | Hu et al. |
| 2006/0080152 | April 2006 | Brown |
| 2006/0189853 | August 2006 | Brown |
| 2006/0200319 | September 2006 | Brown |
| 2006/0235722 | October 2006 | Brown |
| 2006/0241975 | October 2006 | Brown |
| 2006/0259201 | November 2006 | Brown |
| 2006/0259332 | November 2006 | Brown |
| 2006/0271214 | November 2006 | Brown |
| 2006/0285660 | December 2006 | Brown |
| 2006/0285736 | December 2006 | Brown |
| 2006/0287889 | December 2006 | Brown |
| 2006/0287931 | December 2006 | Brown |
| 2006/0293572 | December 2006 | Bulat |
| 2007/0011320 | January 2007 | Brown |
| 2007/0016445 | January 2007 | Brown |
| 2007/0021984 | January 2007 | Brown |
| 2007/0061167 | March 2007 | Brown |
| 2007/0073113 | March 2007 | Squilla et al. |
| 2007/0118588 | May 2007 | Brown |
| 2007/0130287 | June 2007 | Kumar et al. |
| 2007/0156893 | July 2007 | Brown |
| 2007/0168242 | July 2007 | Brown |
| 2007/0168504 | July 2007 | Brown |
| 2007/0213605 | September 2007 | Brown |
| 2007/0265869 | November 2007 | Ryckman et al. |
| 2007/0299321 | December 2007 | Brown |
| 2008/0051638 | February 2008 | Iliff |
| 2008/0051640 | February 2008 | Iliff |
| 2008/0052119 | February 2008 | Iliff |
| 2008/0052318 | February 2008 | Iliff |
| 2008/0059247 | March 2008 | Iliff |
| 2008/0162393 | July 2008 | Iliff |
| 2009/0083066 | March 2009 | Bailey et al. |
| 2009/0240115 | September 2009 | Bluth |
| 2009/0240116 | September 2009 | Bluth |
| 2009/0240524 | September 2009 | Bluth |
| 2009/0240527 | September 2009 | Bluth |
| 2009/0240528 | September 2009 | Bluth |
| 2009/0240702 | September 2009 | Bluth |
| 2009/0241177 | September 2009 | Bluth |
| 2010/0030580 | February 2010 | Salwan |
| 2010/0146300 | June 2010 | Brown |
| 2010/0274835 | October 2010 | Brown |
| 2011/0004487 | January 2011 | Schoenberg |
| 2011/0009707 | January 2011 | Kaundinya et al. |
| 2011/0106557 | May 2011 | Gazula |
| 2011/0122995 | May 2011 | Ferro, Jr. |
| 2011/0161475 | June 2011 | Raghavendran et al. |
| 2011/0191117 | August 2011 | Hashim-Waris |
| 2011/0288888 | November 2011 | Gazula |
| 2012/0004525 | January 2012 | Brown |
| 2012/0130647 | May 2012 | Brown |
| 2012/0130739 | May 2012 | Crane |
| 2012/0179479 | July 2012 | Waterson et al. |
| 2012/0185278 | July 2012 | Brown |
| 2015/9043217 | May 2015 | Cashman |
| 2012/0253837 | October 2012 | Cashman |
| 2013/0013333 | January 2013 | Gopinathan et al. |

### DESCRIPTION

### Background of the Invention

Medical services are traditionally provided to individuals at a health care providers' facility. Typically, an individual contacts the medical care provider when the individual requires some type of medical assistance. The health care provider/s then sets an appointment time and date for the individual to see the health care provider/s. Many times, the time, physical place and date of the appointment are inconvenient and/or delayed for the ill patient despite exponential growth of the causative internal pathogens. Furthermore, the individual seeking medical assistance may be exposed to other patients (and expose them) with more serious contagious diseases at the provider facility. In such situations, many individuals go to an emergency room of a hospital or some type of medical clinic (e.g., Minute Clinic, Take Care Clinic, Urgent Care Clinic, etc.), assuming that such clinics are available or convenient to visit. In other situations, especially in smaller towns and rural areas, a medical facility may be located miles away thus making access difficult for compromised patients resulting in individuals who need immediate medical care to delay or not seek the advice of care providers including the added burden/energy of subsequent separate travel to pharmacies to obtain prescribed medication when necessary in almost 80% of all primary care visits.

The costs associated with visiting any health care provider/s can be costly in time, energy and finances depending on the type of insurance, if any, the individual carries. When an individual visits the emergency room of a hospital or multispecialty clinic, the medical costs can be substantially higher medically through exposures to more severe communicable medical conditions and financially if insurance coverage may be limited to various types of visits. Insurance coverage and the cost of the visit may also vary at various clinics. In many communities, multispecialty clinics are not readily available, thus the individual must either visit the health care provider/s/s individually or go to the hospital if appointments are not readily available. In any health provider facility, the risk of communicating serious disease from one patient to another can be unnecessarily escalated exponentially.

Various pharmacy and drug stores have begun offering medical services on their premises. These locations generally offer flu shots and very basic medical services, and are typically provided by a nurse practitioner, not a physician. As such, only very limited types of medical services are offered at such locations. With the IPWP private, secure locations inside the pharmacy or pharmacy supported location, reduced exposure to more serious diseases, increased accessibility, better outcomes facilitated by simultaneous multispecialty consults and reduced human and natural resources energy for separate visits multiple providers including the primary care provider and the medication dispensing pharmacy/tele pharmacy/supported facility at a minimum. This results in significantly reduced cost of care with better team-involved outcomes that can be accomplished with a variety of off the shelf, web based, HIPPA/FDA compliant technologies easily setup inside pharmacy supported facilities (i.e. actual pharmacies, Minute Clinics, educational facilities, workplaces with RX support such as Toyota/Walmart Georgetown, Ky.).

In view of the current state of decreasing health care providers per population and inequitable distribution of quality care, there is an urgent need and Federal mandate to provide medical services in a more convenient, desirable, timely and cost effective manner with better patient outcomes and access.

### SUMMARY OF THE INVENTION

The present invention is directed to a method and apparatus for providing medical services, diagnoses, mental health counseling, and/or wellness consult/advice to individuals in a convenient, desirable, timely, accessible, high quality, multispecialty optioned and cost effective manner. The novel medical system of the present invention and the novel method (process) for providing medical services, diagnoses, mental health advice, and/or wellness advice addresses the current deficiencies that exist for providing medical services to underserved individuals.

In one non-limiting aspect of the invention, there is provided a method and system for providing medical services, diagnoses, health, and/or wellness advice to individuals that includes a remote medical service arrangement wherein a patient can receive various types of medical advice and services remotely from one or more health care provider/s (e.g., doctor, pharmacist, specialty provider, nurse practitioner, nurse, psychologist, psychiatrist, optometrist, physician assistant, pharmacist, health coach, dietitian, medical assistant, etc.). Traditionally, a patient was required to go to a medical facility (e.g., hospital, medical clinic, doctor's office, etc.) to personally meet with and be diagnosed by the health care provider/s/s. The present invention is directed to a method wherein medical services, diagnoses, health advice, and/or wellness advice can be dispensed by a health care provider/s at a location that is remote from the patient. The present invention can be used to provide services in one or more different medical specialties simultaneously (e.g., Allergy; Andrology; Anesthesia; Angiology; Athletic training; Aviation medicine; Cardiology; Dentistry; Dermatology; Disaster medicine; Emergency medicine; Endocrinology; Family medicine; Gastroenterology; General practice; Medical genetics; Geriatrics; Gerontology; Gynecology; Hematology; Hepatology; Immunology; Infectious diseases; Intensive care medicine; Internal medicine; Military medicine; Nephrology; Neurology; Nuclear medicine; Obstetrics; Oncology; Ophthalmology; Oral and maxillofacial surgery; Orthopedics; Otolaryngology; Paleopathology; Palliative medicine; Pathology; Pediatrics; Podiatry; Psychiatric specialties; Psychiatry; Pulmonology; Radiology; Rehabilitation medicine; Rheumatology; Serology; Sexual health; Sleep medicine; Space medicine; Sports medicine; Surgery; Rural medicine, Toxicology; Transplantation medicine; Tropical medicine; Urology; Wilderness medical emergencies; and/or Wilderness medicine). The method and system of the present invention can be used to provide initial screening, treatment, and/or follow-up treatment for a patient user patient. The method and system of the present invention can be used in many situations as an alternative for a patient visiting a medical facility or multispecialty doctor's office/clinic. However, it can be appreciated that the device of the present invention could be located in a private space in a pharmacy or pharmacy supported location. In one non-limiting arrangement of the present invention, there is provided an audio and/or video link between one or more health care provider/s located at one or more locations simultaneously (e.g., health care provider/s's office, health care provider/s's home, hospital, etc.) and the patient is located at some other pharmacy supported location (e.g., shopping mall, shopping center, drug store, grocery store, department store, warehouse store, discount retailer, discount department store, truck trailer, mobile office, mobile home, office space location, pharmacy, educational facility, workplace, etc.) that is remote from the one or all of the health care provider/s/s. The novel method of the present invention for providing medical services, diagnoses, mental health advice, and/or wellness advice enables a health care provider/s to provide primary and specialty medical services, diagnoses, mental health advice, and/or wellness advice to patients without the patient having to physically visit a health care provider/s or multiple providers and/or having to go to the health care provider/s' office or place of work. As can be appreciated, the audio and/or video link that is used by the health care provider/s can enable the health care provider/s/s to provide medical services, diagnoses, mental health advice, and/or wellness advice at a single remote location or a plurality of remote locations. When the audio and/or video link enables the health care provider/s to provide medical services, diagnoses, health advice, and/or wellness advice to a plurality of remote locations, a single health care provider/s and/or a plurality of health care provider/s can be used to provide medical services, diagnoses, health advice, and/or wellness advice to patients that are located at a variety of different remote locations. When a plurality of health care provider/s is used, the health care provider/s can be located at the same or different locations. As can be appreciated, the novel method for providing medical services allows for more flexibility for a patient to obtain medical services, diagnoses, health advice, and/or wellness advice. The site at which the patient obtains the medical services, diagnoses, health advice, and/or wellness advice via the method and device of the present invention can be located in a) non-traditional locations that are more convenient to a patient (e.g., shopping mall, public park, department store, retail store, grocery store, museum, office building, business office, business facility, big box stores, government base or facility, drug stores, boat, airplane, train, etc.), and/or b) traditional locations (e.g., doctor's office, hospital, urgent care facility, etc.) all of which must be inside a traditional pharmacy or pharmacy supported location (tele pharmacy or electronic medication dispenser adjacent) so as to provide easier and/or more convenient access to such medical services, diagnoses, health advice, including but limited to medication management and/or wellness advice. The geographic location for the device of the present invention can be in a single neighborhood, multiple neighborhoods, a single town or city, multiple towns or cities, a single state or province, multiple states or provinces, a single country, or multiple countries. The novel method can also be used to provide medical services, diagnoses, health advice, and/or wellness advice at standard times (e.g., 9 am-5 pm Monday through Friday, etc.) and/or non-standard times (e.g., early morning hours, evening hours, weekend hours, holiday hours, etc.) to enable a patient to obtain medical services, diagnoses, health advice, and/or wellness advice that are more convenient and timely to the patient up to 24 hrs./day.

As can be appreciated, other or additional types of medical services and/or health care services can be provided. The medical services and/or health care services that can be provided can include, but are not limited to, 1) providing advice and/or recommendations about a medical condition, 2) diagnosing and/or treating a medical condition, 3) providing immediate, simultaneous referral services for a medical condition, 4) prescribing and providing medicine for a medical condition, 5) periodically monitoring a medical condition, 6) providing follow-up checks for a medical condition, 7) providing routine check-up services, 8) providing advice, counseling, and/or recommendations about medical and/or health matters, 9) providing a course of treatment for a medical condition, 8) providing mental health counseling, 10) providing health information, 12) providing wellness counseling, and/or 13) providing wellness information. As can be appreciated, other or additional services can be provided to the patient. In essence, any type of medical condition, medical concern, health concern, wellness concern, etc. can be addressed in whole or part by the novel method and apparatus for providing medical services of the present invention. Hereinafter, these services will be collectively referred to as medical or health care services. As can be appreciated, the type of services provided to a patient will depend on the specific medical condition, medical concern or need, wellness concern or need, and/or mental health concern or need of the patient. In many instances, the health care provider/s will be able to diagnose, address, advise, consult and/or treat the specific medical condition or need, medical concern or need, wellness concern or need, mental health concern or need, etc. of the patient. In some instances, the specific medical condition or need, medical concern or need, wellness concern or need, health concern or need, etc. of the patient may be too complicated and/or complex to address via an audio and/or video link, thus the health care provider/s in such situations may have to refer the patient to a hospital, a doctor's office, counselor, psychiatrist/psychologist, medical specialist, health professional, dietician, rehabilitation facility, or a traditional medical clinic for further counseling, treatment and/or diagnosis, or some other location or professional that can address the patient's needs and/or requirements.

In still another and/or alternative non-limiting aspect of the invention, the novel method and apparatus for providing medical services, diagnoses, health, and/or wellness advice to individuals can include the use of a medical system to enable the patient to conveniently communicate with one or more health care provider/s. One or more medical systems can be used in the present invention. Generally, a plurality of medical systems which are located at one or more locations are used in the method of the present invention; however, it can be appreciated that a single medical system can be used in accordance with the present invention. Typically, one or more health care provider/s provide services to one or more medical systems. The size, shape, configuration and look of the medical system are non-limiting. In one non-limiting embodiment of the invention, the medical system provides a private or semi-private environment for a patient to communicate with one or more health care provider/s that are located remotely from the medical system. In one non-limiting arrangement, the medical system includes a private room, enclosure or booth that is designed to enable a patient to enter the enclosure and to communicate with the health care provider/s in a private or semi-private manner while in the enclosure of the medical system. The size, shape and configuration of the enclosure of the medical system are non-limiting. In another and/or alternative non-limiting arrangement, the medical system includes one or more walls that form all or a portion of the sides of the enclosure of the medical system. The enclosure may include one or more doors or entry points to enable a patient to enter and/or exit the enclosure. In another and/or alternative non-limiting arrangement, the medical system typically includes a floor and/or a ceiling. The ceiling, when included, can include a portion that is partially or fully transparent; however, this is not required. In another and/or alternative non-limiting arrangement, the medical system can have a modular configuration to enable the parts of the medical system to be set up in various configurations to enable the medical system to be used in various types of spaces and/or to be set up in various types of configurations. The medical system can be formed of any number of materials (e.g., plastic, foam, metal, wood, composite materials, fiber board, etc.). The one or more walls of the medical system can be designed to be interchangeable to enable the door, when used, to be positioned on various locations on the medical system; however, this is not required. The medical system can include a floor and/or ceiling to provide for increased privacy for the patient when the patient is inside the room, cavity or enclosure of the medical system; however, this is not required. The medical system can include one or more tables, ledges, benches, and/or seats in the interior and/or exterior of the medical system; however, this is not required. Such table, ledge, bench, and/or seat, when used, can be designed to be connected in multiple locations on the exterior and/or interior of the medical system; however, this is not required. The modular configuration of the medical system can be such that it can be easily assembled and moved so that the medical system can be easily brought into a location and easily set up, and/or be easily removed from a location; however, this is not required.

In yet another and/or alternative non-limiting aspect of the invention, the novel method and apparatus for providing medical services, diagnoses, health, and/or wellness advice to individuals can include the use of a medical system that includes one or more data input terminals. The one or more data input terminals can be located on one or more locations on the medical system; however, this is not required. The one or more data input terminals can include a video display to display information regarding identification and/or data entry, a camera and/or video camera used to collect information for identification and/or data entry, a key pad or key board for identification and/or data entry, a touch screen for identification and/or data entry, microphone and voice recognition software for identification and/or data entry, fingerprint scanner for identification and/or data entry, retina scanner for identification and/or data entry, and/or face and/or body scanners for identification and/or data entry. As can be appreciated, other or additional devices can be included on the medical system to display and/or obtain information regarding identification and/or data entry. The medical system can be used by the patient to enter/convey basic information about the patient. Such information includes, but is not limited to, a) patient name, b) patient address, c) patient contact information (e.g., home address, work address, phone number, email address, pager number, work number, etc.), d) patient age, e) patient sex, f) patient height, g) patient weight, h) patient medical history, i) current medicines used by patient, j) reason(s) for visit by patient, k) patient current symptoms, l) patient insurance information, m) patient payment information, n) patient's current doctor, o) guardian or patent information, p) next of kin information, q) desired health care provider/s for visit, r) allergy information, s) information about a prior visit, t) medical records information, and/or u) pharmacy information. As can be appreciated, other or additional information can be inputted/conveyed by the patient.

In still another and/or alternative non-limiting aspect of the invention, the novel method and apparatus for providing medical services, diagnoses, health, and/or wellness advice to individuals can include a medical system that can be designed to provide information to the patient prior to and/or during the inputting/conveying of information by the patient to the medical system. In one non-limiting embodiment of the invention, the medical system can include audio and/or visual instructions and/or displays used to provide a) information about the medical system, b) how to use the medial system, c) how to properly input/convey information to the medical system, d) provide instructions and/or interactions with the patient during the inputting/conveying of information by the patient to the medical system, e) the wait time for the patient's use of the medical system, f) a list of patient's waiting to use the medical system, g) available health care provider/s, h) types of medical issues that can be addressed by use of the medical system, i) insurance providers that can be used to partially or fully pay for a visit in the medical system, j) payment options for use of the medical system, k) information regarding when the medical system in the future is available, and/or l) information regarding whether the medical system is in use or is available.

In yet another and/or alternative non-limiting aspect of the invention, the novel method and apparatus for providing medical services, diagnoses, health, and/or wellness advice to individuals can include a scheduling system for use of the medical system. The schedule system allows a patient to schedule an appointment with a health care provider/s when the patient uses the medical system. The scheduling system can be used to 1) enable a patient to select a particular health care provider/s, 2) make an appointment on a medical system at a particular time and place, 3) enable a patient to select a health care provider/s or type of medical provide based on the particular need of the patient (e.g., select a health care provider/s that specializes in dermatology to address a rash issue on the patient, select a health care provider/s that specializes in orthopedics to address a sports injury to the knee, etc.), 4) locate available locations of medical systems, 5) enable a patient to enter basic information about the patient, 6) check a past, current or future appointment of the patient regarding use of the medical system, 7) enter a partial or fully payment for use of the medical system, 8) enter medical insurance information, etc. The scheduling system can be designed to be accessed by a patient on a data entry device on a medical system, via a computer or phone or smart device, and/or by phone. The scheduling system can optionally be designed to enable a patient to request assistance if there a question regarding the use of the scheduling system.

In still yet another and/or alternative non-limiting aspect of the invention, the novel method and apparatus for providing medical services, diagnoses, health, and/or wellness advice to individuals can include one of more software applications (e.g., patent registration application, attendant application, patient appointment or registration application, health care provider/s application, administrator application, patient portal, provider portal, etc.). For example, the Patient Appointment or Registration Application can include the screens the patient navigates through during the patient registration process; however, this is not required. These screens can optionally appear on the registration station of the exterior of the medical system. The Attendant Application can include screens that the medical attendant, when used, navigates through during the patient appointment; however, this is not required. These screens can optionally appear on a laptop, computer screen, tablet, smart phone, etc. located with the medical attendant and/or at or near the attendant desk on the exterior of the medical system; however, this is not required. The Patient Appointment or Registration Application can include screens the patient navigates through during the patient consultation; however, this is not required. These screens can optionally appear on the health care provider/s screen and/or patient screen in the interior of the medical system. The Provider Application can include the screens the health care provider/s navigates through during the patient appointment; however, this is not required. These screens can optionally appear on the health care provider/s's computer, laptop, tablet, smart phone, etc. at his/her remote location. As can be appreciated, other or additional software and/or hardware application can be used with the medical system of the present invention. The Patient Appointment or Registration Application can allow the patient to select a language to be displayed (e.g., English, Spanish, German, French, Chinese, Japanese, etc.); however, this is not required.

In another and/or alternative non-limiting aspect of the invention, the novel method and apparatus for providing medical services, diagnoses, health, and/or wellness advice to individuals can include the use of a Patient Appointment or Registration Application to navigate patients through the vitals capture process, patient consultation, and/or survey; however, this is not required. The Patient Appointment or Registration Application can contain one or more navigational buttons on the patient screen that is located inside the medical system (e.g., back, next, cancel, request assistance, etc.); however, this is not required. The “Back” button, when used, allows the patient to return to the previous screen. The “Next” button, when used, allows the patient to proceed to the next screen. The “Cancel” button, when used, allows the patient to cancel a process and return to the beginning of the process. The patient can optionally receive a request to confirm the cancel procedure; however, this is not required. If the blood pressure cuff requires that it be connected to the medical system, the patient user can perform such connection. The patient can start the blood pressure reading by selecting a button on the Patient Appointment or Registration Application; however, this is not required. The blood pressure cuff can be used to measure the blood pressure/heart rate of a patient. A real-time reading of the blood pressure/heart rate of a patient can be displayed on the Patient Screen and/or Provider Screen; however, this is not required. The patient can stop the process of capturing the blood pressure/heart rate of the patient or any other biometric monitoring; however, this is not required. After the completion of capturing of all the vitals, The Patient Appointment or Registration Application can be designed to display on the Patient Screen and/or Provider Screen a summary of one or more of the captured vitals. Patient Appointment or Registration Application can be designed to allow a patient to manually change one or more of the collected vials; however, this is not required. Once the vital capture process is completed, the patient can be prompted (e.g., “I'm Ready” button, etc.) to indicate that the patient is ready for the conference with the health care provider/s; however, this is not required. The Patient Appointment or Registration Application can be designed to notify the patient that the health care provider/s will be with them shortly; however, this is not required. Once the consultation has begun, the Patient Appointment or Registration Application can be designed to cause the health care provider/s to appear on the lower half of the Provider Screen and the patient's vitals appear on the upper half of the Provider Screen; however, this is not required. As can be appreciated, the full Provider Screen can only include the health care provider/s. The Patient Appointment or Registration Application can be designed to allow the patient to adjust the volume by use of volume buttons on the Patient Screen; however, this is not required. As can be appreciated, volume control can be located in other or additional locations in the medical system. After the completion of the consultation, the Patient Appointment or Registration Application can be designed to ask the patient to complete a survey; however, this is not required. The Patient Appointment or Registration Application can be designed to allow the patient to skip the survey, when used, or to proceed with the survey; however, this is not required

In still another and/or alternative non-limiting aspect of the invention, the novel method and apparatus for providing medical services, diagnoses, health, and/or wellness advice to individuals can include the use of a Provider Application that is designed to enable the health care provider/s to navigate through the appoint process during the patient appointment. The Provider Application can be designed to allow the health care provider/s to a) display appointment, b) display patient information, c) view and/or modify visit information, d) perform the consultation, and/or e) utilize one or more medical devices in the medical system. The Provider Application can be designed to cause screens to appear on the health care provider/s's computer, smart phone, tablet, etc. at the health care provider/s's remote location; however, this is not required. Upon entering the Provider Application, the health care provider/s, the Provider Application can be designed to enable the health care provider/s to view appointments that have been completed by the health care provider/s, that are in progress by the health care provider/s and/or which are future appointments. In one non-limiting arrangement, the Provider Application can be designed to enable the health care provider/s to view appointments that have been completed by the health care provider/s or are in progress for a certain day (e.g., today, last Monday, etc.). In another non-limiting arrangement, the Provider Application can be designed to enable the health care provider/s to view appointments that have been made for a future time (e.g., two hours from the present, the next day, etc.). For example, the Provider Application can be designed to display on one portion of the screen (e.g., left side, right side, center, etc.) appointments for “Today” and “Future.” In one non-limiting arrangement, the “Today” tab can be designed to display one or more types of patient appointment information (e.g., Time—Time of appointment, Patient Name—Patient Name for appointment, Status—Status of appointment, Pending—Patient started the registration process, but has not yet been approved for payment, Checked-In—Patient has been checked-in, Pre Consult—Appointment has started and vitals are being collected, In Visit—Vitals have been collected and the video consultation is in-progress, Post Consult—Video consultation has been completed and health care provider/s completion is pending, Completed—Appointment has been completed, etc.). The “Future” tab can be designed to display one or more types of patient appointment information (e.g., Date—Date of appointment, Time—Time of appointment, Patient Name—Patient Name for appointment, etc.). The Provider Application can be designed to enable the health care provider/s to view a selected record on another portion of the screen; however, this is not required. The selected record can provide the health care provider/s one or more types of information (e.g., Patient Name, Patient Date of Birth, Patient Sex, Symptoms, Medical Conditions, Date of Last Visit, Diagnosis, Allergies, Medications, Prior Visit Record of Patient, Medical Records of Patient, etc.). The Provider Application can be designed to enable the health care provider/s notify the medical attendant that the patient requires assistance; however, this is not required. The Provider Application can be designed to enable the health care provider/s to view the appointment and/or patient information prior to the vitals capture process. The Provider Application can be designed to limit access to a patient's information until a certain point (e.g., patient status is “Checked-In”, etc.); however, this is not required. The Provider Application can be designed to enable the health care provider/s to refuse an appointment that has been created for the health care provider/s; however, this is not required. Generally, such refusal should occur prior to the patient status of “Checked-In” to enable the system to locate another available health care provider/s; however, this is not required. The Provider Application can be designed to allow the health care provider/s to begin the conference with the patient once the patient is ready in the medical system (e.g., after “Check-In”, after “Capture of Vitals”, etc.); however, this is not required. The Provider Application can be designed to cause a “Start Visit” button or similar button to appear on the health care provider/s's screen to allow the health care provider/s to begin the consultation with patient; however, this is not required. Once the visit or consultation has been initiated, the Provider Application can be designed to update the appointment status to “In Visit”; however, this is not required. Once the visit or consultation has begun, the patient appears on a portion of the health care provider/s's screen (e.g., right side of screen, center of screen, left side of screen, etc.); however, this is not required. Once the consultation or visit with the patient is terminated, the Provider Application can be designed to cause the status of the patient to change to “Post Consult”; however, this is not required “Post Consult” means the video consultation has been completed and the health care provider/s is completing the visit summary. Once the health care provider/s has completed the visit summary and written any require prescriptions, the Provider Application can be designed to cause a “Complete Appointment” or provide medication similar button to appear on the health care provider/s's screen; however, this is not required. The selection of the “Complete Appointment” button or similar button after completion of the video consultation can result in the status of the patient to change to “Completed”; however, this is not required “Completed” means the health care provider/s has completed input of all information and is ready to commence the next appointment. The Provider Application can be designed to allow the health care provider/s to view the patient records, including the vitals capture process that has occurred or is occurring in the medical system. The Provider Application can be designed to cause one or more tabs to be displayed on the health care provider/s's screen once a patient record has been selected (e.g., Patient Information, Current Visit, Previous Visit, etc.). The “Patient Information” tab, when used, can list one or more types of information of the patient on the health care provider/s's screen (e.g., Personal Information, Medications, Allergies, Medical Conditions, etc.). One or more of these categories of information can be further expanded upon selection by the health care provider/s; however, this is not required. For example, selection of the Personal Information category can cause further information about the patient to be displayed (e.g., date of birth, sex, alcohol usage, smoker status, race, eye color, native language, citizenship, address, etc.); however, this is not required. The “Current Visit” tab, when used, can list one or more types of information of the patient on the health care provider/s's screen (e.g., Medications, Notes, Vitals, Devices, Visit Summary, Attendant Instruction, etc.). One or more of these categories of information can be further expanded upon selection by the health care provider/s; however, this is not required. For example, selection of the Medications category can cause further information about medications used by the patient (e.g., past medications used, past medications prescribed to patient, current medications used by the patient, etc.). The “Previous Visit” tab, when used, can list one or more types of information of the patient on the health care provider/s's screen (e.g., Symptoms, Notes, Vitals, Visit Summary, etc.). One or more of these categories of information can be further expanded upon selection by the health care provider/s; however, this is not required. For example, selection of the Vitals category can cause further information about the vitals that were captured during a previous visit to the current medical system, some other medical system, or at some other medical facility. The “Medications” section allows the health care provider/s to see previously entered medications, search and select new medications, and/or remove medications the patient is no longer taking. The Provider Application can be designed to allow a health care provider/s to add a medication by having the health care provider/s type in the medication and/or to start typing the medication name in the “Search Medications” drop down and allow a listing of matching medication names to appear for selection and then to select the proper medication. The Provider Application can be designed to allow a health care provider/s to delete a medication by having the health care provider/s select an “X” next to the medication. As can be appreciated, other or additional arrangements can be used to add and/or delete medications in a patient's record. The “Allergies” section allows the health care provider/s to view allergies as input by the patient. This function allows the health care provider/s to see previously entered allergies, search and select new allergies, and/or remove allergies. The Provider Application can be designed to allow a health care provider/s to add an allergy by having the health care provider/s type in the allergy and/or to start typing the allergy name in the “Add Allergy” drop down and allow a listing of matching allergy names to appear for selection and then to select the proper allergy. The Provider Application can be designed to allow a health care provider/s to delete an allergy by having the health care provider/s select an “X” next to the allergy. As can be appreciated, other or additional arrangements can be used to add and/or delete allergies in a patient's record. The “Medical Conditions” section allows the health care provider/s to view patient medical conditions as input by the patient. This function allows the health care provider/s to see previously entered medical conditions, search and select new medical conditions, and/or remove medical conditions. The Provider Application can be designed to allow a health care provider/s to add a medical condition by having the health care provider/s type in the medical condition and/or to start typing the medical condition in the “Add Medical Condition” drop down and allow a listing of matching medical condition names to appear for selection and then to select the proper medical condition. The Provider Application can be designed to allow a health care provider/s to delete a medical condition by having the health care provider/s select an “X” next to the medical condition. As can be appreciated, other or additional arrangements can be used to add and/or delete medical conditions in a patient's record. The “Current Visit” tab contains sections for Symptoms, Notes, Vitals, Devices, Visit Summary, and Attendant; however, it can be appreciated that other or additional tab sections can be included. The “Symptoms” section contains all of the patient's symptoms for the current visit as input by the patient. This function allows the health care provider/s to see entered symptoms, search and select new symptoms, and remove symptoms. The Provider Application can be designed to allow a health care provider/s to add a symptom by having the health care provider/s type in the symptom and/or to start typing the symptom in the “Symptoms” drop down and allow a listing of matching symptom names to appear for selection and then to select the proper symptom. The Provider Application can be designed to allow a health care provider/s to delete a symptom by having the health care provider/s select an “X” next to the symptom. As can be appreciated, other or additional arrangements can be used to add and/or delete symptoms in a patient's record. The “Notes” section allows the health care provider/s to enter notes for the current visit. This information generally does not appear on the Appointment Summary and is intended for internal reference only; however, this is not required. The Provider Application can be designed to allow a health care provider/s to add or delete a note by type a note in the note texted box or by deleting a note in the note text box. As can be appreciated, other or additional arrangements can be used to add and/or delete notes in a patient's record. The “Vitals” section contains the patient's vitals for the current visit. They are displayed dynamically on the provider's screen as the vitals capture process takes place; however, this is not required. This function allows the health care provider/s to see the below vitals prior to starting and during the consultation; however, this is not required. This information is generally only displayed and cannot be updated; however, this is not required. Non-limiting vitals can include Height, Weight, Blood Pressure, Heart Rate, Oxygen Saturation, and Temperature. The “Devices” section contains icons of the medical devices that are located in the medical system and/or can be used with the medical system. On the interior of the medical system there can be one or more medical containers (e.g., 1-10, 2, 4, 6, etc.), wherein one or more can be locked upon patient entry into the medical system. The health care provider/s has the capability to unlock one or more of the medical enclosures in the medical system as necessary. When the health care provider/s wants to unlock a medical device enclosure, the health care provider/s clicks on or selects the appropriate medical device icon on the health care provider/s's computer screen. This selection action can result in the activation of the medical device and/or the opening of the medical enclosure door that includes the selected medical device. An audible sound can be generated (e.g., sound of dropping door, sound of a lock unlocking, etc.) when access to a medical enclosure is granted to a patient; however, this is not required. As can be appreciated, a visual indicator can also or alternatively be used to indicate that a patient can access a particular medical enclosure; however, this is not required. Non-limiting medical devices can be included in the medical system can be selected by the health care provider/s for use in a patient visit (e.g., Thermometer, Otoscope, Stethoscope, Derma scope, Pulse Oximeter, Spirometer, Blood Pressure Cuff, blood sugar analyzer, etc.). As can be appreciated, the medical attendant can provide one or more medical devices to a patient prior to and/or during the visit (e.g., Blood Pressure Cuff, etc.). The “Visit Summary” section is comprised of one or more sub-sections, some or all of which are input by the health care provider/s (e.g., Current Diagnoses, Treatment Plan, Follow-Up Care, Visit Documents, etc.). The “Current Diagnoses” section, when used, allows for the provider to input diagnoses codes and descriptions for the current visit. The health care provider/s can update and/or enter a diagnoses by entering the name of the diagnoses and/or an ICD code in a drop down menu and/or search menu. Once the diagnoses name has been entered and/or searched and located, the health care provider/s can add the diagnoses to the patient's record. More than one diagnoses can be added to a patient's record during a single visit. Once the one or more diagnoses are entered, such diagnoses can be optionally displayed under the “Current Diagnoses” section. The “Treatment Plan” section, when used, allows for the health care provider/s to input a treatment plan for the current visit. Such treatment plan can be typed by the health care provider/s into a text box and this information can appear on the Appointment Summary for the patient to reference; however, this is not required. The “Follow-Up Care” section, when used, allows for the health care provider/s to input follow-up care for the current visit. Such follow-up care plan can be typed by the health care provider/s into text box; however, this is not required. This information can appear on the Appointment Summary for the patient to reference; however, this is not required. The “Visit Document” section, when used, allows for the health care provider/s to input follow-up care for the current visit. The health care provider/s can include one or more visit documents and/or other types of documents (e.g., documents about the common cold, documents about rashes, documents about the flu, documents about lice, documents bout acne, etc.) which can be provided to the patient along with the Appointment Summary; however, this is not required.

In yet another and/or alternative non-limiting aspect of the invention, the novel method and apparatus for providing medical services, diagnoses, health, and/or wellness advice to individuals can include a method and a system wherein before the video-conference between the health care provider/s and the patient begins, each patient starts with a Vitals Check to capture the following one or more of the information: Height, Weight, Temperature, Blood Pressure and/or Heart Rate.

In still yet another and/or alternative non-limiting aspect of the invention, the novel method and apparatus for providing medical services, diagnoses, health, and/or wellness advice to individuals can include a method and a system wherein the system includes six advanced medical device enclosures which are locked upon patient entry. During the patient consultation, the health care provider/s has the capability to unlock and lower these enclosures from the Provider Application on the Provider's computer. The following medical devices can be contained within the system, namely a thermometer, an otoscope, a stethoscope, a derma scope, a pulse oximeter and/or a blood pressure cuff. Additional medical devices can be included in the medical system (e.g., scale, height tape, eye chart, blood sugar analyzer, etc.). The stethoscope, when used, is used for detecting sounds produced in the body that are conveyed to the ears of the listener. The medical system stethoscope sounds are transmitted from the stethoscope in the medical device (e.g., hardwire, USB, Bluetooth, etc.) to the health care provider/s's stethoscope. On the interior of the medical system, the stethoscope can be contained in the first medical device enclosure on the left; however, this is not required. The stethoscope can be activated by the health care provider/s via the Provider Application by the health care provider/s selecting the stethoscope icon the provider's screen; however, the stethoscope can be activated by other or additional arrangements. In one non-limiting arrangement, when the health care provider/s via the Provider Application selects the stethoscope icon on the provider's screen, the stethoscope in the medical system is activated and the enclosure door in the medical system for the stethoscope opens or drops down to enable the patient in the medical system to access the stethoscope; however, this is not required. The health care provider/s can provide instructions to the patient on how to use the stethoscope (e.g., Once the patient has removed the device, request for patient to turn on the stethoscope on the stethoscope device. The “On” button is the lower most button on the device; it looks like a smiley face with one eye. Tell the patient to attempt to hold the device on the sides, while using it, so other buttons are not depressed, etc.) and/or instructions for use of the stethoscope can be provided on the Patient Screen and/or Provider Screen in the medical system; however, this is not required. When the stethoscope is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the stethoscope and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s via the Provider Application can increase and/or decrease the volume received from the stethoscope; however, this is not required. As can be appreciated, the patient can increase and/or decrease the volume from the stethoscope; however, this is not required. The health care provider/s and/or patient can request assistance by the medical assistant related to the stethoscope if so required. The otoscope, when used, is a device used for examining the internal ear. The image generated by the otoscope in the medical system can be displayed on the Patient's Screen and/or Provider's Screen in the medical system and/or on the screen being used by the health care provider/s; however, this is not required. The transmission of the signal can be by various means (e.g., hardwire, USB, Bluetooth, etc.). On the interior of the medical system, the otoscope can be contained in the second medical device enclosure on the left in the medical system; however, this is not required. The otoscope can be activated by the health care provider/s via the Provider Application by the health care provider/s selecting the otoscope icon the provider's screen; however, the otoscope can be activated by other or additional arrangements. In one non-limiting arrangement, when the health care provider/s via the Provider Application selects the otoscope icon on the provider's screen, the otoscope in the medical system is activated and the enclosure door in the medical system for the otoscope opens or drops down to enable the patient in the medical system to access the otoscope; however, this is not required. The health care provider/s can provide instructions to the patient on how to use the otoscope (e.g., Once the patient has pulled out the device, request for patient to place the otoscope in the appropriate ear lobe, then adjust the focus dial. The focus dial is on the top of the otoscope. The patient can push it to the top and then dial it down to determine to focus; To direct the patient to maneuver the otoscope for best image capture, use the interior of the medical system as reference points. Once the device is in the patient's ear canal, instruct them (or the individual assisting them) to move the device towards the front, back, bottom, and top of the medical system, etc.) and/or instructions for use of the otoscope can be provided on the Patient Screen and/or Provider Screen in the medical system; however, this is not required. When the otoscope is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the otoscope and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s via the Provider Application can adjust the focus of the otoscope; however, this is not required. As can be appreciated, the patient can adjust the focus of the otoscope; however, this is not required. The health care provider/s and/or patient can request assistance by the medical assistant related to the otoscope if so required. The thermometer, when used, is used for detecting human internal heat. The temperature that is transmitted by the thermometer can be displayed on the Patient's Screen and/or Provider's Screen in the medical system and/or on the screen being used by the health care provider/s; however, this is not required. The transmission of the signal can be by various means (e.g., hardwire, USB, cellular, wireless digital, jetpack, Bluetooth, etc.). On the interior of the medical system, the thermometer can be contained in the third medical device enclosure on the left in the medical system; however, this is not required. The patient's temperature can be collected during the vitals capture process which is prior to the consultation with the health care provider/s; however, this is not required. If the health care provider/s wants the temperature to be retaken or if the temperature of the patient has not already been taken, the thermometer can be activated or reactivated by the health care provider/s via the Provider Application by the health care provider/s selecting the thermometer icon the provider's screen; however, the thermometer can be activated by other or additional arrangements. In one non-limiting arrangement, when the health care provider/s via the Provider Application selects the thermometer icon on the provider's screen, the thermometer in the medical system is activated and the enclosure door in the medical system for the thermometer opens or drops down, if not already open, to enable the patient in the medical system to access the thermometer; however, this is not required. The health care provider/s can provide instructions to the patient on how to use the thermometer (e.g., Once the patient has pulled out the device, request for patient to turn on the thermometer. The “On” button is on the inside handle of the device; Request for the patient to insert the thermometer into their ear and press the button on top of the handle to start the reading. Once the patient's temperature is collected, a beep will sound; Once the beep is sounded to indicate the temperature reading has completed, the patient can hit the “Temperature Recorded” button on the patient screen, etc.) and/or instructions for use of the thermometer can be provided on the Patient Screen and/or Provider Screen in the medical system; however, this is not required. When the thermometer is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the thermometer and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s and/or patient can request assistance by the medical assistant if so required. In one non-limiting arrangement, the temperature must register between 95.0 degrees and 105.9 degrees; however, this is not required. Temperatures under or above 95.0 degrees and 105.9 degrees can be designed to create an error and request the patient to manually enter their temperature, request the patient to try again to take a proper temperature, and/or request the medical assistant to assist the patient related to the thermometer; however, this is not required. The derma scope, when used, is used to visualize body surface, skin, hair, scalp, eyes, and/or throat with magnification and/or illumination. The image generated by the derma scope in the medical system can be displayed on the Patient's Screen and/or Provider's Screen in the medical system and/or on the screen being used by the health care provider/s; however, this is not required. The transmission of the signal can be by various means (e.g., hardwire, USB, Bluetooth, etc.). On the interior of the medical system, the derma scope can be contained in the first medical device enclosure on the right in the medical system; however, this is not required. The derma scope can be activated by the health care provider/s via the Provider Application by the health care provider/s selecting the derma scope icon the provider's screen; however, the derma scope can be activated by other or additional arrangements. In one non-limiting arrangement, when the health care provider/s via the Provider Application selects the derma scope icon on the provider's screen, the derma scope in the medical system is activated and the enclosure door in the medical system for the derma scope opens or drops down to enable the patient in the medical system to access the derma scope; however, this is not required. The health care provider/s can provide instructions to the patient on how to use the derma scope (e.g., Once the patient has pulled out the device, request for patient to place the derma scope device at the appropriate place, then request for the patient to adjust the focus dial. The focus dial is on the top handle of the derma scope. The patient can push it to the top and then dial it down to determine appropriate focus, etc.) and/or instructions for use of the derma scope can be provided on the Patient Screen and/or Provider Screen in the medical system; however, this is not required. When the derma scope is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the derma scope and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s via the Provider Application can adjust the focus of the derma scope; however, this is not required. As can be appreciated, the patient can adjust the focus of the derma scope; however, this is not required. The health care provider/s and/or patient can request assistance by the medical assistant related to the derma scope if so required. The pulse oximeter, when used, is used for measuring the amount of saturated hemoglobin in the tissue capillaries by transmitting a beam of light through the tissue to a receiver. The image generated by the pulse oximeter in the medical system can be displayed on the Patient's Screen and/or Provider's Screen in the medical system and/or on the screen being used by the health care provider/s; however, this is not required. The transmission of the signal can be by various means (e.g., hardwire, USB, Bluetooth, etc.). On the interior of the medical system, the pulse oximeter can be contained in the second medical device enclosure on the right in the medical system; however, this is not required. The pulse oximeter can be activated by the health care provider/s via the Provider Application by the health care provider/s selecting the pulse oximeter icon the provider's screen; however, the pulse oximeter can be activated by other or additional arrangements. In one non-limiting arrangement, when the health care provider/s via the Provider Application selects the pulse oximeter icon on the provider's screen, the pulse oximeter in the medical system is activated and the enclosure door in the medical system for the pulse oximeter opens or drops down to enable the patient in the medical system to access the pulse oximeter; however, this is not required. The health care provider/s can provide instructions to the patient on how to use the pulse oximeter (e.g., Provider: Once the patient has pulled out the device, request for patient to place the device on their index finger as illustrated by the diagram on the top on the device. The picture is a finger nail print which should align to the patient's finger nail, etc.) and/or instructions for use of the pulse oximeter can be provided on the Patient Screen and/or Provider Screen in the medical system; however, this is not required. When the pulse oximeter is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the pulse oximeter and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s via the Provider Application can adjust the focus of the pulse oximeter; however, this is not required. As can be appreciated, the patient can adjust the focus of the pulse oximeter; however, this is not required. The health care provider/s and/or patient can request assistance by the medical assistant related to the pulse oximeter if so required. The scale, when used, is used to obtain the weight of the patient. The weight that is transmitted by the scale can be displayed on the Patient's Screen and/or Provider's Screen in the medical system and/or on the screen being used by the health care provider/s; however, this is not required. The transmission of the signal from the scale can be by various means (e.g., hardwire, USB, Bluetooth, etc.). On the interior of the medical system, the scale can be located on the floor of the medical system; however, this is not required. The patient's weight can be collected during the vitals capture process which is prior to the consultation with the health care provider/s; however, this is not required. If the health care provider/s wants the patient's weight to be retaken or if the patient's weight has not already been taken, the scale can be activated or reactivated by the health care provider/s via the Provider Application by the health care provider/s selecting the thermometer icon the provider's screen; however, the scale can be activated by other or additional arrangements. In one non-limiting arrangement, when the health care provider/s via the Provider Application selects the scale icon on the provider's screen, the scale in the medical system is activated to enable the patient in the medical system to obtain the weight of the patient; however, this is not required. The health care provider/s can provide instructions to the patient on how to use the scale (e.g., Request for the patient to step on or sit on the scale without moving and wait for the recording to be completed, etc.) and/or instructions for use of the scale can be provided on the Patient Screen and/or Provider Screen in the medical system; however, this is not required. When the scale is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the scale and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s and/or patient can request assistance by the medical assistant if so required. In one non-limiting arrangement, the weight must register no greater than 501 pound or some other upper limit; however, this is not required. Weights that are above the upper weight limit can be designed to create an error and request the patient to manually enter their weight, request the patient to try again to take a proper weight, and/or request the medical assistant to assist the patient related to the scale; however, this is not required. The scale can be positioned in any location in the medical system (e.g., floor, bench, chair, etc.). In one non-limiting embodiment, the can be integrated into the medical system in such a way that it at least partially incorporated in on the floor of the medical system. In one non-limiting design, the scale is positioned flush with the floor so that it poses no safety challenges for the patient user/patient in the medical system; however, this is not required. As can be appreciated, the size, shape, and type of scale are non-limiting. The scale in the floor of the system can also optionally be used as designated standing location of a patient so that a height of the patient can be obtained by used of one or more cameras and/or other electron devices in the medical system; however, this is not required. The blood pressure cuff, when used, is used to determine the arterial pressure of the systemic circulation. The information that is transmitted by the blood pressure cuff can be displayed on the Patient's Screen and/or Provider's Screen in the medical system and/or on the screen being used by the health care provider/s; however, this is not required. The transmission of the signal from the scale can be by various means (e.g., hardwire, USB, Bluetooth, etc.). On the interior of the medical system, the blood pressure cuff can be contained in the third medical device enclosure on the right in the medical system; however, this is not required. Alternatively, the blood pressure cuff can be kept with the medical attendant, and the medical attendant then assists the patient in placing the blood pressure cuff on the patient prior to the patient entering the medical system or while the patient is located in the medical system; however, this is not required. The patient's blood pressure can be collected during the vitals capture process which is prior to the consultation with the health care provider/s; however, this is not required. If the health care provider/s wants the patient's blood pressure to be retaken or if the patient's blood pressure has not already been taken, the blood pressure cuff can be activated or reactivated by the health care provider/s via the Provider Application by the health care provider/s selecting the blood pressure cuff icon the provider's screen; however, the blood pressure cuff can be activated by other or additional arrangements. In one non-limiting arrangement, when the health care provider/s via the Provider Application selects the blood pressure cuff icon on the provider's screen, the blood pressure cuff in the medical system is activated and the enclosure door in the medical system for the blood pressure cuff opens or drops down to enable the patient in the medical system to access the blood pressure cuff; however, this is not required. As can be appreciated, if the blood pressure cuff is not located in a medical enclosure, that patient can obtain the blood pressure cuff from the location that the blood pressure cuff currently exists in the medical system or the medical assistant can provide the blood pressure cuff to the patient if the medical attendant is retaining the blood pressure cuff. In another non-limiting arrangement, the medical system includes an ambidextrous blood pressure cuff. The cuff arm can optionally be mounted to the desk top to enable the blood pressure cuff to be moved from side to side of the desk top; however, this is not required. Such movement of the blood pressure cuff enables the blood pressure cuff to be positioned so that the left arm or right arm of a patient user can be inserted into the blood pressure cuff when the patient user is facing the desk top. As can be appreciated, when a blood pressure cuff is included in the medical system, it can be mounted and/or positioned in the medical system in a variety of ways. Information to and from the blood pressure cuff, when used, can be transmitted by wire and/or wirelessly to one or more computers, processors, storage devices, etc. in the medical system and/or to a location remote from the medical system. The ambidextrous blood pressure cuff, when used, may be made of high-strength plastic or any other sufficiently rigid and/or strong material (e.g., metal, composite material, etc.). The cuff arm can be designed to be manually moved by the patient/patient user, be remotely moved by the health care provider/s and/or medical system assistant, and/or be electronically moved by the patient/patient user. The blood pressure cuff can be designed to be activated/deactivated by the patient/patient user and/or remotely by the health care provider/s and/or medical system assistant. The health care provider/s can provide instructions to the patient on how to use the blood pressure cuff (e.g., The blood pressure cuff is most effective when the patient fully places their bicep in the cuff, with the palm of their hand facing the ceiling, etc.) and/or instructions for use of the blood pressure cuff can be provided on the Patient Screen and/or Provider Screen in the medical system; however, this is not required. When the blood pressure cuff is activated, a video image can be designed to appear on the Provider Application (e.g., health care provider/s's screen) and/or the Provider Screen and/or Patient Screen that is located in the interior of the medical system. If a video image option is available for display on the Provider Screen and/or Patient Screen that is located in the interior of the medical system, the health care provider/s via the Provider Application can turn off such video image on the Provider Screen and/or Patient Screen; however, this is not required. The health care provider/s via the Provider Application can capture images and/or data generated by the blood pressure cuff and/or video camera in the medial system for placement in the patient's file; however, this is not required. The health care provider/s via the Provider Application can optionally annotate an image once captured (e.g., use the paint brush and font icons to modify image, etc.) and/or show the captured image to the patient; however, this is not required. The health care provider/s via the Provider Application can start and/or stop the blood pressure operation; however, this is not required. As can be appreciated, the patient can start and/or stop the blood pressure operation; however, this is not required. The health care provider/s and/or patient can request assistance by the medical assistant related to the blood pressure cuff if so required.

In another and/or alternative non-limiting aspect of the invention, the novel method and apparatus for providing medical services, diagnoses, health, and/or wellness advice to individuals can include a scheduling application that 1) enables a health care provider/s to input the day and time the health care provider/s is available to conduct a visit with a patient in a medical system, or see use pattern for walk in access 2) obtains or collects information on appoints that have been made by one or more patients at one or more medical systems, and 3) assigns a health care provider's to a particular appoint that has been made at a particular medical system. The scheduling application can be designed to enable a patient to select a particular health care provider/s, gender of a health care provider/s, specialty of a health care provider/s, a health care provider/s that can speak a certain language, etc.; however, this is not required. The scheduling application can be designed to allow a health care provider/s to refuse an appointment with a particular patient; however, this is not required. If the health care provider/s refuses an appointment, the scheduling application can be designed to attempt to schedule a different appoint for the newly available time slot of the health care provider/s, or can block off such time and not reschedule a new appointment for such time period; however, this is not required. The scheduling application can be designed to select a health care provider/s for a particular appointment based on a set algorithm (e.g., available health care provider/s that has the largest time since last appointment, etc.) and/or by a random process. The scheduling application can be designed to attempt to select a new health care provider/s for a particular appointment if the originally selected health care provider/s is unable and/or unwilling to conduct a visit with a patient in the medical system; however, this is not required.

In still another and/or alternative non-limiting aspect of the invention, the novel method and apparatus for providing medical services, diagnoses, mental health, and/or wellness advice to individuals can include a medication adherence application; however, this is not required. The medication adherence application can be designed to reduce medication errors. The medication adherence application can include a reminder for patients to take their meds and then optionally the system can automatically log when the patient takes their medication; however, this is not required. The medication adherence application can also include the ability to track a patient's compliance to taking their medication on time and/or provide automatic progress reports; however, this is not required. The medication adherence application can also include the ability to refer the patient to the pharmacist onsite (or tele pharmacist if pharmacy supported location) to answer any questions and/or for additional consultation; however, this is not required. Each patient user/patient utilizing the medical system can be automatically enrolled in the e-script network, which network sends their prescriptions to the pharmacy of their choice, fill their prescription at the pharmacy onsite or obtain their medication via the adjacent/nearby electronic medication vending kiosk/machine; however, this is not required. The medication adherence application and immediate dispensing can be used to assist in improving patient outcomes and/or satisfaction. The medication adherence application of the present invention can be designed to be used on a screen in the medical system, and/or on a computer screen and/or mobile device; however, this is not required. The medication adherence application of the present invention can be designed to generate a screen that includes one or more main buttons (e.g., 1) Consult with a tele pharmacist 2) speak with the onsite pharmacist now, 2) Change my medications alerts, 3) Learn about controlling my prescriptions (e.g., cholesterol, high blood pressure, diabetes, etc.), 4) Check orders status, 5) Refill Prescriptions, etc., 6) Transfer prescriptions to another pharmacy (e.g., Walgreens, CVS, Wal-Mart, etc.), 7) Recommended dosage, 8) Period for taking medications, 9) Frequency for taking medications, 10) Information about medications, 11) Generic brands available for medications, 12) Request appointment to speak with a health care provider/s, 13) Entry of compliance information regarding medication usage by patient, etc.); however, this is not required. The screen can include additional buttons (e.g., help button, Finish button, etc.); however, this is not required. The screen can include advertising information; however, this is not required. The selection of one or more of the button can result in additional screens appearing based on the selected button; however, this is not required. If a patient user/patient needs further guidance from the pharmacist regarding the prescribed medication, the patient user/patient can select the first category button to request such information; however, this is not required. The patient/patient user can be provided a number to call and/or allow the patient user to send an email, make a phone call, etc. regarding the question. The patient user/patient can be provided the option to set a new appointment to meet with a health care provider/s regarding the medication; however, this is not required. The patient user/patient can be provided the option to change the medication alerts; however, this is not required. Such change can be requested by telephone, email, text, phone, etc. The frequency and/or type of alert and/or the manner in which the alert is sent to the patient user/patient (e.g., email, twitter, phone message, text, etc.) may also be modified by the patient user/patient; however, this is not required. The patient user/patient may be provided to option to obtain information about certain medical conditions (e.g., cholesterol, blood pressure, migraines, back pain, arthritis, allergies, flu, etc.); however, this is not required. The patient user/patient may be provided the option to obtain the order status, shipment status, etc. for a particular medication; however, this is not required. If allowable by current medication guidelines and/or medical plans, the patient may request to fill their prescriptions directly through the application; however, this is not required. The patient user/patient may be provided the option to change their preferred prescription location; however, this is not required. The patient user/patient may be provided the option to enter information as to whether the prescribed medications are being timely taken and in the proper amounts; however, this is not required. Periodic reports regarding medication compliance can be generated and provided to the patient user/patient via phone, email, text, twitter, etc.; however, this is not required. The medication adherence application of the present invention can be used to allow the patient to more easily obtain and understand the correct use of their prescriptions. In summary, the medication adherence software application allows a patient user/patient to 1) speak to a pharmacist, 2) change the patient's medications alerts, 3) learn about certain types of medical conditions, 4) check medication orders status, 5) check medication delivery status, 6) refill a prescriptions, 7) transfer prescriptions to a another location, 8) obtain information about recommended medication dosages, 9) obtain information about recommended times to take medications, 10) obtain information about recommended frequency for taking medications, 11) obtain information about medications, 12) obtain information about generic brands available for medications, 13) request an appointment to speak with a health care provider/s, 14) enter information regarding compliance information regarding medication usage by patient, and/or 15) receive compliance reports for patients regarding medication usage.

In still yet another and/or alternative non-limiting aspect of the invention, the novel method and apparatus for providing medical services, diagnoses, health, and/or wellness advice to individuals can include digital signage on the exterior of the medical system; however, this is not required. The digital signage, when used, can be displayed through one or more monitors or display screens on the exterior and/or interior of the medical system to able a patient user/patient/potential patient user to see one or more of the monitors or display screens. One non-limiting aspect of this invention is that the one or more monitors or display screens can be used to display advertisements that may be arranged by the originating site; however, this is not required. Another non-limiting aspect of this invention is that one or more of the monitors or display screens can be used to display the current wait time for the medical system and/or the list of scheduled appointments; however, this is not required. The digital signage application can allow various companies to advertise via the medical system, including the business where it is located; however, this is not required. The digital signage application can be tailored to display information for specific patients based upon their conditions; however, this is not required. The digital signage application can include the ability to display a scrolling message at the bottom of the screen, based upon the business's preference; however, this is not required. The one or more display screens and/or monitors can be used to provide various types of information (e.g., registration information, information input by the patient user, advertising information, information about the medical system, information about wait time for a medical system, information as to the order of patient users waiting to use the medical system, information about whether a medical system is available or in use, cable TV, satellite TV, local broadcast TV, infomercial, medical programs, DVD materials, Blu-ray materials, etc.). Patients waiting to enter the medical system can be allowed to view the various advertisements and/or other types of information displayed on the one or more screens; however, this is not required. The patients can see the wait time for their appointment and/or their position in the appointment queue when such information is displayed on the one or more video screens; however, this is not required. Any message necessary for the patient to see can also be displayed upon the screen in the interior of the medical system; however, this is not required (e.g., “Welcome (Patient Name)”, “Your Health care provider/s (Provider Name) Will Begin Your Visit Once You Have First Captured Some Basic Vitals”, etc.). The one or more interior screens are primarily utilized for video conferencing between the patient and the provider, patient data input, and patient instructions, but can also be used to display advertisements and/or other information during periods where the medical system has no appointment queued; however, this is not required. The digital signage application can allow businesses to display advertisements and/or current promotions in a way that will attract the consumer's attention; however, this is not required. The ability to tailor the signage to individual patients and/or population groups makes it very adaptable; however, this is not required. The information on the display can be any language. The information on the display can include subtitles, etc.; however, this is not required.

As can be appreciated, the medical system can be designed to accept voice commands during the registration process; however, this is not required. The display screen can be used to provide various types of information (e.g., registration information, information input by the patient user, advertising information, information about the medical system, information about wait time for a medical system, information as to the order of patient users waiting to use the medical system, information about whether a medical system is available or in use, cable TV, satellite TV, local broadcast TV, infomercial, medical programs, DVD materials, Blu-ray materials, etc.). Another display screen can be positioned above the screen used at the registration station and/or at some other location on the exterior of the medical system; however, this is not required. This other display screen can be used to display various types of information (e.g., advertising information, information about the medical system, information about wait time for a medical system, information as to the order of patient users waiting to use the medical system, information about whether a medical system is available or in use, cable TV, satellite TV, local broadcast TV, infomercial, medical programs, DVD materials, Blu-ray materials, etc.); however, this is not required. In one non-limiting arrangement, the screen used at the registration station and the one or more other displays can be design to display different types of information (e.g., screen used at the registration station displays information related to the registration process and the one or more other displays are used to display one or more types of information that are different from the information displayed on the screen used at the registration station, etc.); however, this is not required. The size of the screen used at the registration station and the one or more other displays can be the same or different. In one non-limiting arrangement, a patient user/patient can be allowed to enter payment information at the registration station (e.g., swipes a credit or debit card, etc.); however, it can be appreciated that payment information can also or alternatively be entered inside the medical system, at the optional attendant station, wirelessly or over a network via a smart phone or other device or by a computer connected to a network, etc. The check-in system in accordance with the present invention offers a new way for organizations to meet rising consumer expectations for convenience and at the same time improve accuracy and usability of information systems; however, this is not required. The check-in system in accordance with the present invention can result in shorter waiting times for check-in, as well as efficiency gains from increased throughput and fewer errors in keeping patient demographic data up to date; however, this is not required. The check-in system in accordance with the present invention can result in the reduction of risk of patient misidentification and clerical errors at data entry; however, this is not required. The check-in system in accordance with the present invention can improve accuracy in language access for those not fluent in English by offering multiple language options during the check-in process; however, this is not required.

In still another and/or alternative non-limiting aspect of the invention, the novel method and apparatus for providing medical services, diagnoses, health, and/or wellness advice to individuals can include a sanitizing system (e.g., UV system, mist system, anti-pathogenic materials, etc.) that can be automatically activated and/or activated by the medical attendant and/or health care provider/s prior to and/or after a patient has used the medical system; however, this is not required. The medical system can include a cleaning system designed to clean the interior of the medical system and/or kill/neutralize some of or all germs and/or other micro-organisms in the medical system; however, this is not required. One non-limiting cleaning system that can be used is an ultraviolet sanitizing system. As can also be appreciated, a mist sanitizer can also or alternatively be used to fully or partially clean/sanitize one or more portions of the medical system. As can be appreciated, other or additional cleaning systems can be used. In another and/or alternative non-limiting aspect of the invention, the medical system can be made of one or more materials that resist growth of bacteria, viruses and/or other micro-organisms; however, this is not required. In one non-limiting embodiment, the floor, walls and ceiling of the medical system include or are fully made of materials that resist or prevent the growth of bacteria, viruses and/or other micro-organisms; however, this is not required. In one non-limiting arrangement, the medical system includes an ultraviolet light sanitization system which can be used in the medical system and which can be activated through software from a remote location and/or by a system attendant; however, this is not required. The ultraviolet light sanitization system can be activated twice daily to ensure the sanitary environment is maintained; however, it can be appreciated, that the ultraviolet light sanitization system can be activated a greater or lesser number of times per day. The location of the ultraviolet light sanitization system, when used, is non-limiting. In one non-limiting arrangement, the ultraviolet light sanitization system can be located in the roof or ceiling of the medical system; however, this is not required. For example, the ultraviolet light sanitization system can be connected or positioned adjacent to the ceiling panel and rear panels; however, this is not required. The ultraviolet light sanitization system can be located in the rear of the medical system where it will be out of the way of the patients utilizing the medical system; however, this is not required. The ultraviolet light sanitizing system generally includes one or more ultraviolet lights that are designed to kill some or all of the germs and/or other micro-organisms in the medical system. Typically the germs and/or other micro-organisms in the medical system are treated when the interior of the medical system does not include a patient user. The sanitizing system can optionally include one or more standard lights that can be used to provide illumination in the medical system; however, this is not required. The sanitizing system can optionally include a cooling fan for the one or more components in the sanitation system; however, this is not required. The sanitizing system can optionally include both a UV and a mist sanitizing system; however, this is not required. The sanitizing system can house one or more cameras, speakers, sensors (e.g., temperature sensor, motion sensor, sound sensor, etc.), etc. for use in the medical system; however, this is not required. The doors to the medical system can be closed and/or locked to prevent a patient user/patent from entering the medical system during a sanitizing process; however, this is not required.

In yet another and/or alternative non-limiting aspect of the invention, the novel method and apparatus for providing medical services, diagnoses, health, and/or wellness advice to individuals can include a medical system that enables a service operator to easily access the various components of the medical system for purposes of service, repair, maintenance, upgrade, replacement, etc. In order to offer the comprehensive service the medical system is capable of, there are multiple components that must be tlinctioning at all times. The various devices that may need service include, but are not limited to, the display screens, the network connection, various other electronics and wiring, fans, lights, electronic switches, backup power supplies, computers, electronic storage devices, doors on the medical equipment compartments, etc. The ability to easily and conveniently access and/or performing maintenance on these components is advantageous to providing the medical system services via the medical system; however, this is not required. To more easily facilitate the service of these components, the medical system can be designed with a moveable front panel; however, this is not required. The front panel can be built on casters, wheel, rail system, etc. to allow the front panel to be easily moved; however this is not required. The front panel can be equipped with a tamper proof lock to prevent unauthorized personnel from accessing the components located behind the front panel; however, this is not required. A portion or the entire front panel can be designed to move in order to ensure that when there is a problem with one or more components used in the medical system, the repair of such components does not require the disassembly of the entire or a substantial portion of the medial system to repair the components; however, this is not required. The components of the medical system that are generally difficult or inaccessible when the medical system is fully assembled are 1) the components that form the exterior check-in station, 2) the interior displays or monitors, 3) the interior speakers, the interior cameras, 4) the interior sound jack, 5) the doors on the medical compartments, 6) the interior microphone, 7) the electronics located behind the exterior check-in station, 8) the electronics located behind the interior AV system, and/or 9) the computer and other electronics used for network communication, control and/or storage; however, this is not required. As can be appreciated, there may be other or additional components of the medical system that are generally difficult or inaccessible when the medical system is fully assembled. Access to one or more of these components can be more easily accessed by the movement of the moveable panels of the medical system; however, this is not required.

In still yet another and/or alternative non-limiting aspect of the invention, the novel method and apparatus for providing medical services, diagnoses, health, and/or wellness advice to individuals can include a method and a medical system that enables the health care provider/s to generate electronic prescriptions and/or for the patient to conveniently select and/order/receive prescription drugs; however, this is not required. In one non-limiting embodiment, this novel method and apparatus will allow patients to 1) choose between name brand and generic drugs, 2) choose the supply quantity for the prescription (i.e., 30 day supply, 60 day supply, 90 day supply, etc.), 3) choose between picking the prescription up at the pharmacy of their choice or mail delivery of the prescription or electronic dispenser if adjacent, 4) enter medical insurance for partial or full payment of the prescription, 5) enter a credit or debit card information to pay for the prescription, 6) enter information for mail delivery of the prescription, 8) enter information to provide automatic reminders to patient regarding refilled and/or follow-up medical visits, 9) enter information to enable a patient to be notified when a prescription has been mailed and/or is ready to be picked-up at the pharmacy; however, this is not required, 10) obtain a print out and/or electronic version of the prescription written by the health care provider/s, and/or 11) receive information about the issued prescription (e.g., prescribed use, side effects, etc.) in printout and/or electronic form; however, this is not required. Another non-limiting aspect of this method and apparatus will allow the patient to select the select the pharmacy if not on site where he/she would like to pick-up the prescription; however, this is not required. In one non-limiting embodiment of the invention, the health care provider/s can generate an electronic prescription for a patient. The prescription can include both the generic and name brand drugs along with the patient copay amount for each; however, this is not required. The electronic prescription can provide additional information (e.g., potential savings for selecting certain medications, the dosage amount, the medication dosage, quantity or strength, name of health care provider/s, help information, etc.), advertising information, etc.; however, this is not required. Once the particular medication brand is selected by the patient, another screen can optionally appear; however, this is not required. For example, the second screen can illustrate the brand of medication selected by the patient/patient user and/or also provides quantity supply options for the medication, etc.; however, this is not required. The second screen can optionally illustrated additional information such as, but not limited to, the copay amount for the selected medication brand and quantity, the monthly, yearly, etc. savings for selecting a particular medication brand and/or quantity, help information, go back option, advertising information, etc.; however, this is not required. The second or a third screen can optionally appear that provides an order confirmation along with the associated savings; however, this is not required. The second or third screen can optionally illustrate additional information such as, but not limited to, the monthly, yearly, etc. savings for selecting a particular medication brand and/or quantity, help information, advertising information, etc. As can be appreciated, other or additional screens can be displayed to the patient user/patient. This aspect of the invention has the advantage of allowing the patient user/patient to view and/or select brand or generic drugs thereby allowing the patient user/patient to decide which drug option is best for them and their budget; however, this is not required. The medical system and method for using the medical system can thus include a point of purchase prescription workflow application allowing a health care provider/s to generate prescriptions and optionally allowing patients to select and/or order prescription drugs; however, this is not required. The medical system and method for using the medical system can include a point of purchase prescription workflow application that allows a patient user/patient to choose his/her drug brand and/or quantity; however, this is not required. The medical system and method for using the medical system can include a point of purchase prescription workflow application that allows a patient user/patient to select the pharmacy from which to pick up his/her prescription; however, this is not required.

In another and/or alternative non-limiting aspect of the invention, the novel method and apparatus for providing medical services, diagnoses, health, and/or wellness advice to individuals can include headphone jacks. The one or more headphone jacks allow for hearing impaired patients to utilize headphones in order to better understand the provider's instructions; however, this is not required. The one or more headphone jacks can also be used to enable additional persons in the medical system (e.g., child's parent, etc.) to listen in on the conversation between the health care provider/s and patient; however, this is not required. The one or more headphone jacks can also be used to provide additional privacy between the health care provider/s and patient; however, this is not required. The headphones may be available from the system and/or the medical attendant; however, this is not required. The headphone jack can be placed at a height allowing any person to reach it if necessary; however, this is not required. The headphones generally will be sanitary either through disposable covers or through another form of sanitization; however, this is not required. The headphone jack can be a standard jack to enable a patient to use his/her own headphone; however, this is not required. The medical system can include a wireless system (e.g., Bluetooth technology, cellular, IR technology, RF technology, etc.) to transmit sound wirelessly to a patient and/or other person located in the medical system; however, this is not required. The system can also be equipped with a wheelchair accessible ramp; however, this is not required. The medical system can be designed to be fully ADA compliant as a result of these novel innovations; however, this is not required. A medical system that includes one or more headphone jacks and/or a wheelchair accessible ramp can permit the medical system to better serve the public at large; however, this is not required.

In still another and/or alternative non-limiting aspect of the invention, the novel method and apparatus for providing medical services, diagnoses, health, and/or wellness advice to individuals can include a medical system that utilizes high definition video and/or high quality sound to create a conference link between a patient located in the medical system and a health care provider/s that is located remotely to the medical system. In one non-limiting aspect of the invention, the medical system includes the use of one or more high definition cameras, one or more high definition monitor(s) and/or high quality speaker(s) built into the medical system; however, this is not required. The one or more cameras located within the medical system can be on an adjustable sliding bar allowing camera positioning to create ideal eye contact; however, this is not required. The one or more cameras in the medical system can be used to enable a health care provider/s to obtain information about a patient user/patient in the medical system (e.g., height, build, sex, skin color, alertness, body cuts, body infections, body rashes, pupil dilation, hygiene, race, physical condition, emotional condition, metal condition, etc.); however, this is not required. In one non-limiting arrangement, one or more monitors and/or display screens can be positioned on the front interior wall of the medical system; however, this is not required. The monitor is generally used to view the one or more health care provider/s when the patient user/patient is located in the medical system; however, this is not required. The shape, size, and thickness of the one or more monitors are non-limiting. One or more cameras can be positioned on the front interior wall, be embedded in the one or more monitor/display screens, and/or be located on a sliding bar allowing it to be positioned relative to the patient user/patient to create better eye contact with the patient user/patient in the medical system; however, this is not required. The one or more cameras enable pictures of the patient user/patient in the medical system to be transmitted to a remotely located health care provider/s; however, this is not required. The remotely located provider typically has a camera at his/her location so that pictures of the health care provider/s can be transmitted to the one or more medical screens in the medical system; however, this is not required. As can be appreciated, a projector can be used as a substitute of one or more monitors in the medical system; however, this is not required. One or more speakers can be positioned on the front interior wall of the medical system; however, this is not required. As can be appreciated, one or more speakers can be positioned on other or additional locations in the medical system; however, this is not required. The speakers can be used to enable a patient user/patient in the medical system to listen to what the health care provider/s is saying to the patient user/patient; however, this is not required. One or more microphones are generally included in the medical system to allow the patient user/patient to communicate with the health care provider/s; however, this is not required.

In yet another and/or alternative non-limiting aspect of the invention, the novel method and apparatus for providing medical services, diagnoses, health, and/or wellness advice to individuals can include a medical system that is modular system that is able to be partially or fully broken down; however, this is not required. In one non-limiting embodiment of the invention, the modular medical system can be partially or fully broken down so as to fit through a doorway (e.g., standard 36″ by 80″ doorway, etc.); however, this is not required. The modular design of the medical system can enables the medical system to be set up in various configurations to enable the medical system to be used in various types of spaces; however, this is not required. The modular design of the medical system can be designed to not only accommodate multiple configurations of the medical system, but can also be designed to facilitate in enabling the medical system to be moved into an existing facility and then allowing the assembly of the medical system in such facility without having to modifying the entry ways into or out of the facility; however, this is not required. The medical system can be formed of any number of materials (e.g., plastic, foam, metal, wood, etc.). The modular configuration of the medical system can be such that it can be easily assembled and disassembled so that the medical system can be easily brought into a location and easily set up; however, this is not required. In still yet another and/or alternative non-limiting aspect of the invention, the novel method and apparatus for providing medical services, diagnoses, health, and/or wellness advice to individuals can include a medical system that is made of one or more materials that resist or prevent the growth of bacteria, viruses and/or other micro-organisms; however, this is not required. In one non-limiting embodiment, the floor, walls and ceiling of the medical system include or are fully made of materials that resist or prevent the growth of bacteria, viruses and/or other micro-organisms; however, this is not required.

In still another and/or alternative non-limiting aspect of the invention, the novel method and apparatus for providing medical services, diagnoses, health, and/or wellness advice to individuals can include a medical system that includes a payment center that enables a patient user to pay for medical services, prescriptions, medical equipment, medical accessories, etc. prior to and/or after the patient user uses the medical system; however, this is not required. The payment center can be in any form (e.g., credit card reader, mobile phone scanner, transmitter/receiver device, electronic scanner, cash receiver, etc.). The payment center may include a touch pad, key board, scanner, receiver, transmitter, credit card/debit card or some other card reader, smart phone or other smart device reader/scanner, finger and/or eye scanner, monitor, chair, table, shelf, printer, instructions on how to use the payment center, etc. The payment center can be located on the exterior and/or interior of the medical system. Generally, the patient user is required to register and pay for the medical services prior to obtaining medical services from the health care provider/s; however, this is not required. In one non-limiting arrangement, the medical system includes a registration station on the exterior of the medical system (e.g., exterior wall of the medical system, on a table exterior to the medical system, etc.); however, this is not required. As can be appreciated, a patient user can be allowed to wirelessly connect to the medical system or to some other computer network so as to wirelessly register and/or enter payment information for use of the medical system; however, this is not required. In such an arrangement, a patient user could register to use a medical system, enter in payment for use of the medical system, set an appointment time for use of the medical system, select a particular medical system to use at some particular location, etc. at some location near or remote from the medical system via a smart phone or other smart device, a computer, etc.

In yet another and/or alternative non-limiting aspect of the invention, the novel method and apparatus for providing medical services, diagnoses, health, and/or wellness advice to individuals can include a medical system that includes an interior cavity or room that provides privacy to the patient when inputting and/or conveying data to the medical system, and/or communicating with a health care provider/s via an audio and/or video link. The size, configuration and/or arrangement of the interior cavity or room are non-limiting. The interior cavity or room can include a) one or more speakers, b) one or more microphones, c) one or more video displays, d) one or more data input device, e) one or more chairs and/or other types of seating areas, f) one or more tables, g) one or more doors, h) one or more shelves, i) one or more compartments used to contain medical supplies, medical instruments, etc., j) one or more light switches, k) one or more power outlets, l) sterilization system, m) one or more headphone jacks, n) one or more lights, o) one or more table tops, p) one or more chair and/or benches, q) one or more doors, r) one or more windows, s) walls, floor and/or ceiling, t) one or more vents, u) one or more power outlets, v) one or more light and/or power switches, w) one or more USB and/or data connection outlets, and/or x) one or more fans. As can be appreciated, the interior cavity or room can include other or additional items. The size and configuration of the interior cavity or room can be designed to enable wheelchair access and maneuvering inside the interior cavity or room; however, this is not required. For example, the size and configuration of the interior cavity or room can be designed to provide sufficient room for the patient so that the patient can easily move within the interior cavity or room and/or the patient does not feel cramped or claustrophobic when in the interior cavity or room; however, this is not required.

In still yet another and/or alternative non-limiting aspect of the invention, the novel method and apparatus for providing medical services, diagnoses, health, and/or wellness advice to individuals can be designed to provide a convenient and low-cost structure (e.g., medical system) that can be placed in many different locations, and which enable patients to conveniently access and obtain medical advice and/or care. Health care provider/s that are located locally or throughout the world can be used to communicate with the patient accessing the medical system. As such, the medical services can be offered year around and at all times so long as there is a qualified health care provider/s somewhere in the world that is available and is qualified to provide medical assistance via the medical system. Such an arrangement can be more convenient to the health care provider/s since the health care provider/s can work from home or from some other convenient location. The arrangement is also convenient to the patient since the patient can access medical assistance via the medical system at the time and place of choosing. Indeed, in rural areas or smaller communities that do not have a local hospital or local multiple specialty provider/s offices nearby, the installation of a medical system in a pharmacy supported local drug store, department store, grocery store, etc., results in more accessible and timely medical care for patients in such communities. The costs associated with providing medical care via the medical system may be less than if the patient seeks medical assistance from a hospital, clinic or doctor's office, thus resulting in the patient potentially saving money. As can be appreciated, other or additional advantages may exist by the method of the present invention.

In another and/or alternative non-limiting aspect of the invention, the novel method and apparatus for providing medical services, diagnoses, health, and/or wellness advice to individuals can include the use of a mobile device (e.g., smart phone, tablet, Ipad, Ipod, PDA, etc.) and/or computer (e.g., desktop computer, laptop computer, ultralight computer, etc.) to enable a patient to 1) conveniently locate an available medical system, 2) schedule an appointment (e.g., date and/or time), 3) pre-register symptoms and/or reasons for visit, 4) set and/or cancel an appointment, 5) received reminders and/or updates regarding appoints, 6) obtain information about medical system availability, 7) obtain information about certain health care provider/s availability, 8) obtain information about the available health care provider/s (e.g., name, specialty, etc.), 9) enable the selection of a certain health care provider/s and/or health care provider/s in a certain field of medicine, 10) obtain map information, address information and/or hours of operation information regarding selected medical system, 11) locate closest system and/or system availability for a certain health care provider/s and/or health care provider/s in a certain field of medicine, 12) pre submit and/or preclear medical insurance, 13) submit payment information, 14) receive information on payment status, 15) receive information on insurance coverage, 16) receive appointment reminders and/or updates, 17) receive prescription information, 18) submit payment information for medical visit and/or prescription, 19) answer surveys regarding the use of the medical system, and/or 20) receive medication reminders. The size, shape, configuration and look of the medical system are non-limiting. In one non-limiting embodiment, this invention will allow patients to schedule appointments using a patient portal through a computer and/or mobile device; however, this is not required. Another non-limiting aspect of the application will allow the patient to select the system location for their appointment. While selecting their appointment time and/or location, the patient can also fill out the symptom survey, select the time of their appointment, and/or select a physician if they choose; however, this is not required. The application can also allow the patient to receive appointment reminders via mobile device, text, phone, cell-phone, web-page, and/or email; however, this is not required. The application may also allow for patients to cancel or change their appointment or see walk in hours; however, this is not required.

In still another and/or alternative embodiment of the invention, the novel method and apparatus for providing medical services, diagnoses, health, and/or wellness advice to individuals can include a mobile application for a portable device (e.g., smart phone, PDA, blackberry device, mobile note device, Ipad, Kindle device, Nook device, tablet device, etc.) and/or a computer based application (e.g., desktop computer, laptop computer, ultralight computer, etc.) that when launched gives the patient user a series of options that can include, but are not limited to, finding a medical system (e.g., medical system, etc.), set medication reminders, visit the home page of the medical system operator, etc. As can be appreciated other and/or additional information can be included on the welcome screen of the mobile application and/or computer based application. The mobile application and/or computer based application can be designed to enable a patient user to 1) search or and/or locate medical systems in one or more communities, towns, cities, states, countries, etc., 2) determine the distance a patient is from a medical system, 3) obtain the directions to a medical system, 4) to view the waiting status and/or availability of a particular medical system, 5) obtain a map to the selected system, 6) obtain information about the hours available for the medical system, 7) obtain information about the actual location picture of the medical system, 8) allow a patient user to make appointment with the medical system, 9) provides information on the hospitals and/or health care provider/s associated with the medical system, 10) provides information on which insurance carriers provide coverage for use of the medical system, 11) obtain information on whether a particular health care provider/s is part of the medical system network of health care provider/s, 12) obtain publics comments about the medical system, 13) contact a helpdesk that provides information about the medical system, 14) schedule an appointment (e.g., date and/or time), 15) pre-register symptoms and/or reasons for visit, 16) enter information required to create an appointment (e.g., personal information, date and time of appointment, particular medical system, particular health care provider/s, insurance information, payments, ID verification, insurance card, etc.), 17) set and/or cancel an appointment, 18) receive reminders and/or updates regarding appoints, 19) obtain information about the available health care provider/s (e.g., name, specialty, etc.), 20) enable the selection of a certain health care provider/s and/or health care provider/s in a certain field of medicine, 21) locate closest system and/or system availability for a certain health care provider/s and/or health care provider/s in a certain field of medicine, 22) pre submit and/or preclear medical insurance, 23) submit payment information, 24) receive information on payment status, 25) receive information on insurance coverage, 26) receive appointment reminders and/or updates, 27) receive medication reminders, and/or 28) receive visit summaries; however, this is not required. In one particular non-limiting arrangement, the mobile application and/or computer based application enables a patient user to schedule an appointment at a medical system. The creation of the appointment can be designed to enable the patient user to a) select the day and/or the time of the appointment, b) select a particular health care provider/s or type of health care provider/s (e.g., pulmonary doctor, gynecologist, etc.), c) provide a reason for visit and/or provide the patient user's symptoms, and/or d) set appointment and medication reminders; however, this is not required. As can be appreciated, other and/or additional information can be inputted by the patient user when making an appointment (e.g., sex, age, weight, height, medical history, use of current medications, symptom, allergies, etc.). The mobile application and/or computer based application can be designed to create an appointment confirmation screen along with text and/or email reminder options; however, this is not required. The confirmation screen, when provided, can provide information about the health care provider/s; however, this is not required. The confirmation screen, when provided, can be designed to enable the patient to change/cancel the appointment; however, this is not required. Several non-limiting advantages of the present invention include allowing a patient to decide which system location is most convenient for the patient. The mobile application and/or computer based application may include an override for “first available” in regards to physician selection; however, this is not required. The patient also may be able to check availability of a preferred health care provider/s and/or the system location; however, this is not required.

In yet another and/or alternative embodiment of the invention, the novel method and apparatus for providing medical services, diagnoses, health, and/or wellness advice to individuals can include a Provider Application wherein the health care provider/s can contact another health care provider/s during a patient visit if a special need or question arises during the patient visit wherein the medical provide believes and/or the patient request a second opinion and/or an opinion from a specialist; however, this is not required. The Provider Application can be designed to enable two or more health care provider/s to be simultaneously viewed and/or heard by the patient in the medical system; however, this is not required. The Provider Application can be designed to allow only one health care provider/s at a time to be viewed and/or heard by the patient in the medical system; however, this is not required. The Provider Application can be designed to allow an interpreter to appear to the health care provider/s and/or patient (e.g., language translator, sign language translator, etc.); however, this is not required. The Provider Application can be designed to allow a medical provide to contact another party (e.g., patient, guardian, relative, etc.) to obtain information, authorization, etc. about/for a patient using the medical system; however, this is not required.

In still yet another and/or alternative embodiment of the invention, the novel method and apparatus for providing medical services, diagnoses, health, and/or wellness advice to individuals can include an administrator application allowing a medical administrator to remotely access one or more components of the medical system; however, this is not required. The administrator application can optionally include one or more functions selected from the group consisting of 1) allowing remote access to one or more medical devices in the medical system, 2) allowing remote access to one or more computers in the medical system, 3) allowing remote access to one or more routers in the medical system, 4) allowing remote access to one or more displays on the medical system, 5) allowing remote access to one or more power supplies in the medical system, 6) allowing remote access to one or more servers in the medical system, 7) allowing remote access to one or more hard drives/memory storage systems in the medical system, 8) allowing diagnostics to be executed from a remote location on one or more electronic components in the medical system (e.g., computer, router, server, battery backup, hard drive/memory storage devices, medical devices, electronic locks, fans, displays, speakers, camera, headphone jack, electronic scale, Bluetooth devices, lights, pumps, scanners, touch pad, ID verification devices, printer, etc.), 9) allowing the rebooting and/or reinitializing from a remote location of one or more electronic components in the medical system, 10) allowing for review of the current and/or past status from a remote location of one or more electronic components in the medical system, 11) allowing hardware and/or software updates to be remotely sent and/or loaded onto one or more electronic components in the medical system, and/or 12) allowing software to be loaded onto and/or removed from one or more electronic components in the medical system.

In another and/or alternative embodiment of the invention, the novel method and apparatus for providing medical services, diagnoses, health, and/or wellness advice to individuals can include a pharmaceutical dispensing system that dispenses medications to the patient; however, this is not required. The pharmaceutical dispensing system can be located on the medical system or be a unit separate from the medical device. The pharmaceutical dispensing system can be designed to allow the patient to obtain the medication with or without the assistance of the medical attendant. The pharmaceutical dispensing system can be designed to only dispense medication that was authorized by the health care provider/s. In one non-limiting arrangement, the health care provider/s can use the Provider Application to send instructions to the pharmaceutical dispensing system to dispense certain types and/or amounts of medication to the patient; however, this is not required. Such information can be stored by the health care provider/s in the patient's record; however, this is not required. The health care provider/s can send notification to the pharmacist that medication is being dispensed to the patient; however, this is not required. The send information can include type and/or quantity of medication; however, this is not required. The payment for medication and/or materials from the pharmaceutical dispensing system can be by mobile device, payment at the medical system, payment at attendant's station, and/or payment at the pharmaceutical dispensing system and/or by some other method and/or at some other location.

In still another and/or alternative embodiment of the invention, the novel method and apparatus for providing medical services, diagnoses, health, and/or wellness advice to individuals can include a data port and/or wireless receiver that can be used by a patient to download and/or upload information to a medical device on a patient (e.g., heart monitor, heart pacemaker, implantable cardioverter defibrillators, etc.). Such information can be designed to be viewed by the health care provider/s, and/or data can be sent to the medical device by the health care provider/s; however, this is not required.

In yet another and/or alternative embodiment of the invention, the novel method and apparatus for providing medical services, diagnoses, health, and/or wellness advice to individuals can designed to be transported to various locations to be used an emergency medical station; however, this is not required. For example, after a natural disaster (e.g., flood, hurricane, tidal wave, earthquake, fire, tornado, etc.), the medical system of the present invention can be transported to the area of the incident and then be used as an emergency medical station. As can be appreciated, the medical system can be continuous transported to various locations (e.g., remote rural locations, camp sites, etc.) to enable individuals in such locations to obtain medical assistance.

In still yet another and/or alternative embodiment of the invention, the novel method and apparatus for providing medical services, diagnoses, health, and/or wellness advice to individuals can be designed to allow patients to rate the health care provider/s and/or to view the ratings of health care provider/s that have offered services to patients in the medical system; however, this is not required. Such ratings can be used by patients to select a certain health care provider/s for a visit, if such option is available.

In still yet another and/or alternative embodiment of the invention, the novel method and apparatus for providing medical services, diagnoses, health, and/or wellness advice to individuals can designed to generate a fresh scent in the medical system; however, this is not required. The type of scent and/or method of scent delivery are non-limiting.

In another and/or alternative embodiment of the invention, the novel method and apparatus for providing medical services, diagnoses, health, and/or wellness advice to individuals can designed to collect information about patients, patient retention, and/or patient referrals for use in the marketing of the medical system and/or to improve/alter/enhance the services provided by the medical system; however, this is not required.

In still another and/or alternative embodiment of the invention, the novel method and apparatus for providing medical services, diagnoses, mental health, and/or wellness advice to individuals can designed to print and/or send coupons, advertisements, marketing literature, and/or medical literature to a patient that has used the medical system and/or has registered with the medical system; however, this is not required. Such coupons, advertisements, marketing literature, and/or medical literature can be general in nature and/or targeted to the particular patient and/or type of diagnoses received by the patient. For example, if a prescription has been written by the health care provider/s, one or more pharmacies may have a coupon sent to the patient to provide the patient with a discount, etc. if the patient fills the prescription at the pharmacy; however, this is not required.

It is one non-limiting object of the invention to provide tele-med services that are convenient to a patient user.

It is another and/or alternative one non-limiting object of the invention to provide tele-med services that are cost effective to a patient user.

It is still another and/or alternative one non-limiting object of the invention to provide tele-med services that can be provided to a patient user via a medical system.

It is yet another and/or alternative one non-limiting object of the invention to provide tele-med services that can be provided to a patient user via a modular medical system.

It is still yet another and/or alternative one non-limiting object of the invention to provide a medical system and method for using a medical system that is easy to assemble, transport and disassemble.

It is another and/or alternative one non-limiting object of the invention to provide a medical system and method for using a medical system that includes an easy and convenient registration system and payment system.

It is still another and/or alternative one non-limiting object of the invention to provide a medical system and method for using a medical system that provides privacy to a patient user when obtaining medical services.

It is yet another and/or alternative one non-limiting object of the invention to provide a medical system and method for using a medical system that is sized and shaped to accommodate disabled or handicapped patient users.

It is still yet another and/or alternative one non-limiting object of the invention is to provide a medical system and method for using a medical system that includes real time electromechanical biometric monitoring devices that can be used by a patient user when obtaining medical services.

It is another and/or alternative one non-limiting object of the invention to provide a medical system and method for using a medical system that includes video conferencing capabilities between a patient user and a health care provider's.

It is yet another and/or alternative one non-limiting object of the invention to provide a medical system and method for using a medical system that includes a pharmacy or pharmacy supported electronic medication dispensing machine, digital signage, and/or a registration station on the exterior of the medical system.

It is still yet another and/or alternative one non-limiting object of the invention to provide a medical system and method for using a medical system that includes a Provider/s Screen and/or Patient Screen in the interior of the medical system.

It is another and/or alternative one non-limiting object of the invention to provide a medical system and method for using a medical system that includes one or more medical device enclosures on the interior of the medical system.

It is still another and/or alternative one non-limiting object of the invention to provide a medical system and method for using a medical system that includes the use of a Patient Appointment or Registration Application, Attendant Application, Patient Appointment or Registration Application, Provider Application, Administrator Application, Patient Portal and/or Provider/s Portal.

It is yet another and/or alternative one non-limiting object of the invention to provide a medical system and method for using a medical system that includes a Patient Appointment or Registration Application that enables patients to schedule an appointment or view walk in use patterns/hours at a medical system.

It is still yet another and/or alternative one non-limiting object of the invention to provide a medical system and method for using a medical system that includes Patient Appointment or Registration Application that enables a patient to enter insurance information and/or to make a payment and/or copay for the medical visit in the system.

It is another and/or alternative one non-limiting object of the invention to provide a medical system and method for using a medical system that includes Patient Registration System that enables a patient to check-in for health care consult.

It is still another and/or alternative one non-limiting object of the invention to provide a medical system and method for using a medical system that includes a Patient Registration System that enables a patient to identify the patient's symptoms, medications, allergies, and/or medical conditions.

It is yet another and/or alternative one non-limiting object of the invention to provide a medical system and method for using a medical system that includes registration and/or check-in system that enables a patient to request assistance from a medical attendant or pharmacy staff.

It is still yet another and/or alternative one non-limiting object of the invention to provide a medical system and method for using a medical system that includes an Attendant Application that enables a medical attendant to monitor past, present and/or future appointments for the medical system.

It is yet another and/or alternative one non-limiting object of the invention to provide a medical system and method for using a medical system that includes an Attendant Application (or pharmacy staff) that informs that medical attendant that the patient requires assistance.

It is still yet another and/or alternative one non-limiting object of the invention to provide a medical system and method for using a medical system that includes an Attendant Application (or pharmacy staff) that enables the medical attendant to keep track of the clean-up of the medical system.

It is another and/or alternative one non-limiting object of the invention to provide a medical system and method for using a medical system that enables the medical assistant to activate an automated sanitation and/or cleaning system of the medical system.

It is still another and/or alternative one non-limiting object of the invention to provide a medical system and method for using a medical system that includes an Attendant Application that enables a medical assistant to validate the insurance and/or ID of a patient.

It is yet another and/or alternative one non-limiting object of the invention to provide a medical system and method for using a medical system that includes a Patient Appointment or Registration Application that helps the patient capture vitals and/or enter the vitals information during the visit.

It is still yet another and/or alternative one non-limiting object of the invention to provide a medical system and method for using a medical system that includes a Patient Appointment or Registration Application that enables the patient to request assistance from the medical attendant or pharmacy staff.

It is another and/or alternative one non-limiting object of the invention to provide a medical system and method for using a medical system that includes a Patient Appointment or Registration Application that can assist the patient during the consultation with the health care provider/s.

It is yet another and/or alternative one non-limiting object of the invention to provide a medical system and method for using a medical system that includes a Provider/s Application that assists the health care provider/s in providing medical services to the patient in the medical system.

It is still yet another and/or alternative one non-limiting object of the invention to provide a medical system and method for using a medical system that includes a Provider/s Application that provides information to the health care provider/s regarding past, current and future appointment that have been schedules with the health care provider/s.

It is another and/or alternative one non-limiting object of the invention to provide a medical system and method for using a medical system that includes a Provider Application that enables the health care provider/s to view personal information that the patient has entered regarding the medical visit.

It is still another and/or alternative one non-limiting object of the invention to provide a medical system and method for using a medical system that includes a Provider/s Application that enables the health care provider/s to view biometric vitals that have been collected on the patient.

It is yet another and/or alternative one non-limiting object of the invention to provide a medical system and method for using a medical system that includes a Provider Application that enables the health care provider/s to request that the medical attendant assist the patient in the medical system.

It is still yet another and/or alternative one non-limiting object of the invention to provide a medical system and method for using a medical system that includes a Provider Application that enables the health care provider/s to control the use and/or access of one or more medical devices in the medical system.

It is another and/or alternative one non-limiting object of the invention to provide a medical system and method for using a medical system that includes a Provider Application that enables a health care provider/s to create a visit summary of the patient in the medical system.

It is still another and/or alternative one non-limiting object of the invention to provide a medical system and method for using a medical system that includes a Provider Application that enables the health care provider/s to update personal information, medical history information and/or symptom information about the patient.

It is yet another and/or alternative one non-limiting object of the invention to provide a medical system and method for using a medical system that includes a Provider/s Application that enables a health care provider/s to select and/or enter a diagnosis for a patient.

It is still yet another and/or alternative one non-limiting object of the invention to provide a medical system and method for using a medical system that includes a Provider Application that enables the health care provider/s to enter notes about a patient and/or create a treatment plan for a patient.

It is another and/or alternative one non-limiting object of the invention to provide a medical system and method for using a medical system that includes a Provider Application that enable a health care provider/s to view information about past visits by a patient.

It is still another and/or alternative one non-limiting object of the invention to provide a medical system and method for using a medical system that includes a mobile application and/or an online application that enables a patient to 1) conveniently locate an available medical system, 2) schedule an appointment (e.g., date and/or time) or alternatively walk in hours, 3) pre-register symptoms and/or reasons for visit, 4) set and/or cancel an appointment, 5) received reminders and/or updates regarding appoints, 6) obtain information about medical system availability, 7) obtain information about certain health care provider/s availability, 8) obtain information about the available health care provider/s (e.g., name, specialty, etc.), 9) enable the selection of a certain health care provider/s and/or health care provider/s in a certain field of medicine, 10) obtain map information, address information and/or hours of operation information regarding selected medical system, 11) located closest system and/or system availability for a certain health care provider/s and/or health care provider/s in a certain field of medicine, 12) pre submit and/or preclear medical insurance, 13) submit payment information, 14) receive information on payment status, 15) receive information in insurance coverage, 16) receive appointment reminders and/or updates, and/or 17) receive medication reminders, and the like.

It is yet another and/or alternative one non-limiting object of the invention to provide a medical system and method for using a medical system that includes a scale in/on the medical system.

It is still yet another and/or alternative one non-limiting object of the invention to provide a medical system and method for using a medical system that includes a medication adherence application that allows a patient user/patient to 1) consult with a pharmacist, 2) change the patient's medications alerts, 3) learn about certain types of medical conditions, 4) check medication orders status, 5) check medication delivery status, 6) refill or fill a prescriptions, 7) transfer prescriptions to a another location, 8) obtain information about recommended medication dosages, 9) obtain information about recommended times to take medications, 10) obtain information about recommended frequency for taking medications, 11) obtain information about medications, 12) obtain information about generic brands available for medications, 13) request an appointment to speak with a health care provider/s, 14) enter information regarding compliance information regarding medication usage by patient, and/or 15) receive compliance reports for patients regarding medication usage.

It is another and/or alternative one non-limiting object of the invention to provide a medical system and method for using a medical system that includes a medication adherence application that 1) sends reminders for patient user/patients to take their medications, 2) monitors a patient user's/patient's adherence to taking their meds and/or distributes progress reports to the patient, and/or 3) automatically enrolls a patient in an electronic prescriptions network which can optionally send a patient's prescriptions to their choice of pharmacy.

It is still another and/or alternative one non-limiting object of the invention to provide a medical system and method for using a medical system that includes one or more headphone jacks in the medical system.

It is still yet another and/or alternative one non-limiting object of the invention to provide a medical system and method for using a medical system that includes a medical system having a modular configuration and/or a configuration that enables the medical system to be brought in to or removed from locations having a standard sized doorway.

It is another and/or alternative one non-limiting object of the invention to provide a medical system and method for using a medical system that includes a medical system having a check-in registration system positioned on the exterior of the medical system.

It is still another and/or alternative one non-limiting object of the invention to provide a medical system and method for using a medical system that includes a medical system having one or more medical device enclosures located in the interior of the medical system.

It is yet another and/or alternative one non-limiting object of the invention to provide a medical system and method for using a medical system that includes a medical system having digital signage on the interior and/or exterior of the medical system.

It is still yet another and/or alternative one non-limiting object of the invention to provide a medical system and method for using a medical system that includes a medical system having a built-in sanitation system.

It is another and/or alternative one non-limiting object of the invention to provide a medical system and method for using a medical system that allows patients to 1) choose between name brand and generic drugs, 2) choose the supply quantity for the prescription (i.e., 30 day supply, 60 day supply, 90 day supply, etc.), 3) choose between picking the prescription up at the pharmacy of their choice, the onsite pharmacy or electronic delivery of the prescription, 4) enter medical insurance for partial or full payment of the prescription, 5) enter a credit or debit card information to pay for the prescription, 6) enter information for mail or electronic delivery of a prescription, 8) enter information to provide automatic reminders to patient regarding refilled and/or follow-up medical visits, 9) enter information to enable patient to be notified when prescription has been mailed and/or is ready to be picked-up at the pharmacy; however, this is not required, 10) obtain a print out and/or electronic version of the prescription written by the health care provider/s, and/or 11) receive information about the issued prescription (e.g., prescribed use, side effects, etc.) in printout and/or electronic form.

These and other objects and advantages will become apparent to those skilled in the art upon reading and following the description taken together with the accompanying drawing (FIG. 1).

### BRIEF DESCRIPTION OF THE DRAWING

Reference may now be made to the drawings which illustrate various preferred embodiments that the invention may take in physical form and in certain parts and arrangement of parts wherein:

FIG. 1 is an exploded view of a medical system in accordance with the present invention;

### DETAILED DESCRIPTION OF ONE NON-LIMITING EMBODIMENTS

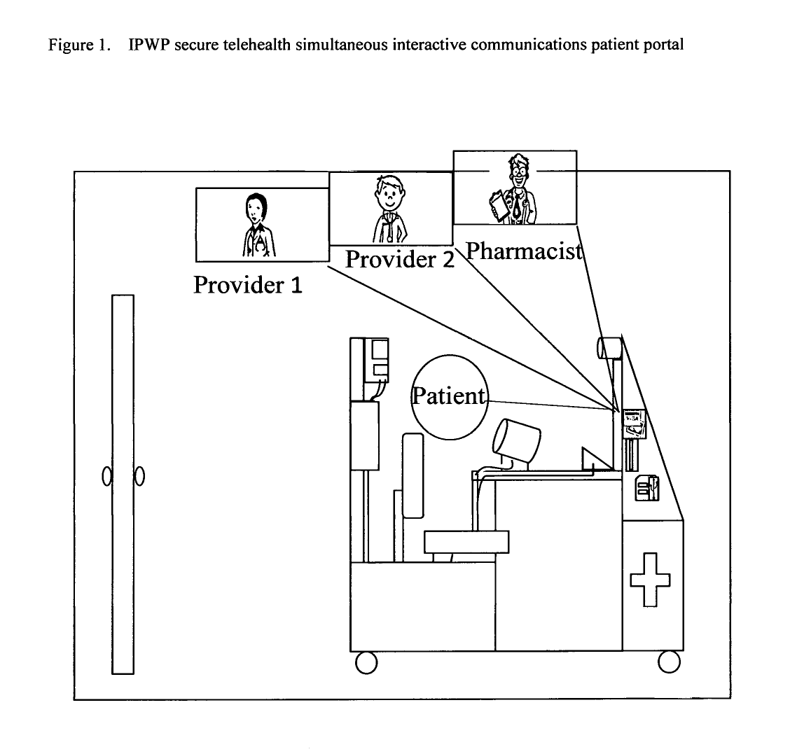

Referring now to the drawings wherein the showings are for the purpose of illustrating one non-limiting embodiments of the invention only and not for the purpose of limiting same, FIG. 1 illustrate one non-limiting embodiment of the medical system in accordance with the present invention. The medical system is designed to be used by a patient user to obtain medical services. Such medical services are generally tele-med services wherein one or more health care provider/s located at a remote location provide medical services to a patient user that are using the medical system. As can be appreciated, non-tele-med services can also be provided to a patient user that is using the medical system.

The shape, size and configuration of the medical system are non-limiting. The materials and colors of the medical system are also non-limiting. Generally, the materials used to form the medical system include materials that resist or prevent microbial growth; however, this is not required. The medical system illustrated in FIG. 1 is designed to accommodate about 1 patient user.

The medical system can be designed to be modular so that it can be easily assembled, transported and disassembled; however, this is not required. FIG. 1 illustrates one non-limiting set of modular components of the medical system. A weight scale can optionally be partially or fully embedded in the floor or seat area. As can be appreciated, a weight scale can be placed on the top surface of the floor panel and/or positioned on other regions of the medical system (e.g., chair, bench, etc.). The weight scale, when used, provides information about the weight of a patient user. The information from the scale can be electronically (e.g., wired, wirelessly) transferred to a health care provider/s and/or displayed to the patient user and/or health care provider/s.

The medical system can optionally include an exterior attendant (pharmacy staff) station that is connected to and/or positioned near the medical system.

The medical system and method for using the medical system are a novel and advanced healthcare delivery system wherein patients and multiple health care provider/s can engage in real-time interactive, simultaneous consultations, providing convenient and affordable healthcare services. The medical system includes the latest technologies in medical devices, video conferencing, and VoIP telephony so that the medical system can extend traditional healthcare to convenient retail pharmacy locations or other locations in a patient user's neighborhood, therein enabling a patient user to see a health care provider/s and obtain a prescription, if required, in a fast and convenient manner.

Some advantageous aspect of the medical system and medical method are: Patient Portal (Cloud/web Based). Provider Portal (Cloud/web Based). Integrated Pharmacy operations. Facilitates Efficient Delivery of Basic Healthcare Delivery. Automates All Aspects of a Check Up. Easy Check-In. Biometric Vital Signs Capture. Prescription Generation and immediate filling. Post Care and Outcomes. Convenient Locations Where Consumers are in need.

The medical system and medical method can be used to provide primary and/or urgent care services in four (4) simple steps:

Step 1—Patient begins/completes check-in process via web portal or at the medical system. The patient can optionally begin the check-in via web/cell portal and then later complete check-in process at the medical system; however, this is not required. A health care provider/s can send a reminder to patient regarding an appointment and/or begin the check-in process for a walk in patient (e.g., follow-up appointment, etc.); however, this is not required.

Step 2—Health care provider/s receives eligible request and accepts and/or is assigned to patient.

Step 3—Patient visits the medical system and has a private scheduled or walk in appointment with a doctor via the Patient Screen.

Step 4—Visit is completed. The medical system and/or health care provider/s can then provide additional care/services that include: prescription, billing information, education, referrals, follow up and/or EMR/PHR entry. The health care provider/s can cause the medical system to printout and fill prescriptions through electronic dispensing and/or directly send the prescription request to the onsite pharmacy. The medical system can print out a bill after the medical services are provided and/or accept payment prior to or after medical services are provided. The medical system can be designed to accept and/or process medical insurance information provided by the patient user. The medical system can print out and/or display education materials/information relevant to/requested by the patient user and/or provided by the health care provider/s. The medical system and/or health care provider/s and/or attendant can schedule a follow-up visit for the patient user. Email, twitter, Facebook, test, and/or mail reminders can be sent to the patient user regarding scheduled and/or follow-up visits. The health care provider/s and/or attendant can schedule a visit with another health care provider/s and/or admit the patient user to the hospital, contact an ambulance, etc. during or after the visit to the medical system. A visit summary can be printed out and/or sent to the patient. As can be appreciated, the medical system and method for using the medical system can have other or additional features.

Advantageous portal features of the medical system and associated medical method are: Practice Management System. Appointments Scheduling System. Online Eligibility, Claims, and Billing System. e/Prescribing with immediate filling and Alerts/Reminders. Medical Records Interface and Access. Personal Health Record (PHR). Electronic Medical record (EMR). Rules-Based Care Plans. Rules-Based Education. Check In Pathway to Care system. Secure Video Conferencing System. Documentation Module. Appointment Storage and Analysis. Education and Post Care.

Some non-limiting advantages to patients by use of the medical system and medical method are: Convenient. Closer to home. Saves time. Language and culture friendly. Better Access. Personal doctor available while traveling. Larger selection of doctors. Not limited by doctor's visitation schedule. More Accurate. Review record of appointment. Automatic data entry into PHR. Less Exposure to Illness.

Some non-limiting advantages to health care provider/s by use of the medical system and medical method are: Higher Revenues. More appointments/day. Les traveling. More Accurate. Review record of appointment. Automatic data entry into EMR/HER. Integrated Care. Real time Referral and transfer. Load Balancing.

Appointment load can be shared with other doctors regardless of location.

Some non-limiting advantages to payers by use of the medical system and medical method are: Change in Status. Transition from Payer to Provider. Market Leverage. New Business Model. Call Center based Nurse Practitioner. Efficiency. Market Demand. Les Overhead. Scalability. Less Liability.

The medical system of the present invention is an Integrated Care Terminal that is a highly equipped provider/s office that is built and designed to deliver urgent and minor medical care in the field utilizing a centralized team of doctors for the evaluation and treatment of patients. The medical system can be fitted with the latest FDA approved/HIPPA compliant medical devices used by doctors today.

Employing the latest technology that is used in physician offices and emergency rooms, the medical system is able to allow patients to obtain appropriate care in locations that are convenient, accessible, and more affordable.

The medical system is designed to be a comfortable, self-contained, secure, sanitary, soundproof system. The medical system can be made of extruded plastics and related components. The interior of the medical system can contain one or more of the following integrated medical devices: Thermometer (e.g., temperature taken via ear, temperature taken via ear, IR thermometer to scan head or other area of body, etc.). Scale built into the patient seat or floor for measuring the patient's weight. Otoscope—for examining the middle ear, exterior ear, nasal passages, mouth and throat. Oximeter which measures the blood oxygen saturation. Stethoscope for evaluation of heart, lung and bowel sounds. Blood Pressure Cuff to measure blood pressure. EKG which provides a snapshot of the heart rhythm and data regarding stress or injury to the heart muscle. Spirometer and transducer for measuring lung function. Blood glucose measuring device or monitor. Retinal scan device (e.g., fingerprint, retinal scan device, etc.). Derma scope.

A medical attendant (e.g., medical assistant, nurse assistant, nurse, nurse practitioner, physician, etc.) who resides outside the medical system can be responsible for answering patient user questions, assisting with patient user registration/payment, thoroughly clean the medical system after each use, and restock and/or reset the medical system after each use. The cleaning of the medical system can include sanitizing the seat, touch screen, floor, walls, seat, and all instruments as well as ensuring the medical system is free of debris and any patient belongings. The medical system can also be designed to be automatically sterilized after one or more patient users use the medical system by utilizing a chemical mist sterilization technology and/or UV sterilization technology. The medical attendant can also ensure that any insurance forms required by the patient user/patient for reimbursement are provided via a printer or some other means contained in the exterior and/or interior of the medical system.

The medical system can also contain one or more computers, which are connected to the internet and powers the one or more monitors and/or other type of equipment in the medical system; however, this is not required. The exterior monitor on the medical system can be used for patient registration and appointment selection that can be conducted in a touch screen format.

The method for providing medical services via a medical system regarding protocols for scheduling, diagnosing, delivering and documenting telehealth primary care can include:

a. Health care provider/s Application—this application is used by the health care provider/s to provide clinical services. The application contains all that the health care provider/s requires to diagnose, deliver care and document the clinical episode. It runs on the provider's computer and can be integrated with the leading EMR applications.

b. Patient Application—this application is used by the patient to register with a medical system and also captures the patient's medical history and/or vitals. It includes all the information required to administer clinical services to the patient. This includes financiaUbilling information and an Electronic Medical Record (EMR), which can be accessed by the patient and the health care provider/s.

c. Integrated videoconferencing software—this application supports the live patient-clinician interaction required for delivery of the clinical services. It uses a secure connection to the servers and the provider/s via an internet connection.

To use a medical system, the patient users/patients may go through one or more of the following steps:

a. Go Online, register and schedule an appointment at the nearest terminal or walk-in and register at the medical system.

b. Use the scheduling System to select an appointment time.

c. Input insurance, preferred pharmacy method/location and/or billing information, and remit payment.

d. Complete pre-appointment pathway to care.

e. Visit a medical system and see a health care provider/s via the integrated care terminal.

f. Pick up prescription, if indicated, at the pharmacy/dispenser.

g. Optionally use website to manage patient user's care until patient user is improved.

The following example is a non-limiting example as to what one patient user may encounter when using the medical system of the present invention:

Some of the non-limiting features of the medical system are: Integrated Medical Devices. Exterior Check-In Station. Patient Waiting Area. Integrated Wi-Fi Hot Spot. Touch Screen Patient user Interface. HIPAA Compliant Design. Instant Sterilization. Video/Audio Conferencing. Flexible Access. Handicap. Parent and Child. Modular design for Pharmacy door deployment. Small Footprint. Fully Integrated Interior Design. Expandable Device Rail. Secure PC storage with access. Open design feels comfortable. Payment and Signature. Finger Print Reader. Integrated Printer. Integrated Medical Devices. Thermometer—(e.g., temperature taken via ear, temperature taken via ear, IR thermometer to scan head or other area of body, etc. Scale built into the patient seat or floor for measuring the patient's weight. Otoscope—for examining the middle ear, exterior ear, nasal passages, mouth and throat. Oximeter which measures the blood oxygen saturation. Stethoscope for evaluation of heart, lung and bowel sounds. Blood Pressure Cuff to measure blood pressure. EKG which provides a snapshot of the heart rhythm and data regarding stress or injury to the heart muscle. Spirometer and transducer for measuring lung function. Blood Glucose measurement device and/or monitor to measure blood glucose levels. Retinal scan device to view structures in the eye. Derma scope to view the skin and/or throat. Exterior Check-In Station—A monitor and keyboard is generally mounted on the outside of the medical system to allow for new patient user/patient registration and check in. The station can be designed to take payment and/or a fingerprint. The station generally is located away from the entrance to the medical system to allow a degree of separation from the patient inside the medical system. The attendant can use this station for her work. Patient Waiting Area—Can include a small area to put a few chairs outside the medical system to act as a waiting area. Integrated Wi-Fi Hot Spot—In order to minimize network connection cost, a Wi-Fi hot spot can partner with an ISP of choice (AT&T, Verizon, Sprint, T-Mobile, etc.). Touch Screen Patient user Interface—The patient can be allowed to interact while inside the medical system by use of a touch screen interface. HIPAA Compliant Design—HIPAA requires patient information to be secure. This will mean the medical system will generally be sound proof and a passerby cannot see in and see any patient information. The medical system generally is fully enclosed and lockable, but can allow exterior access in case of emergency. Instant Sterilization—Because of the many germs and other contaminants that will be inside the medical system, a sterilization technology can be used in the medical system. One type of sterilization system that can be used is a built-in sanitizing misting system that dispenses from a series of misters between every appointment. Another or additional sterilization system that can be used is a UV lighting system that can be blasted between appointments. Other techniques and technologies can also or alternatively be used. The attendant can have the ability to activate one or more sterilization systems (e.g., via button, computer, etc.). The attendant can be required to keep track of records about the sanitization process and can ensure that the doors to the medical system are closed/locked during the sterilization process. Video/Audio Conferencing—The patient will communicate with the health care provider/s via video and audio conferencing technology. This environment can make the patient feel as close to the health care provider/s as actually being present as possible. A two-way glass can be used to place the camera in the center of the monitor to keep the patient looking head on, versus the Skype and current video conferencing solutions that keep patient users looking at the camera and back to the monitor. Flexible Access—The medical system should have a large enough door to accommodate a wheel chair. It should also be large enough inside to allow a parent to sit with a child and not feel constrained. Modular design for Pharmacy door deployment—Most Pharmacies today only have a standard door. The medical system is built in a manner that allows it to enter through the door and quickly be assembled or preassembled on wheels (or modular on site assembly). Small Footprint—Because of the cost of retail space, the medical system will be small enough to fit in most locations. Expandable Devices—The medical system can include the latest medical devices and update such medical devices in a more rapid manner than the average doctors' office. The medical system can include a mounting system that allows medical devices in the medical system to be easily accessed by the patient user. An indicator, such as a light, can be used to notify which medical device is to be used by the patient user. Secure PC storage with access—Because uptime of the software is so important, electronics can be inserted in a compartment in the medical system. Such area generally should be secure, cooled, and easily accessible for service. Payment and Signature—The medical system can include an integrated credit/debit card swipe for payment, and a signature pad for medical authorization. Finger Print Reader—A finger print reader can be included on the medical system to confirm patient ID under HIPAA. Integrated Printer—An integrated printer can be included in the medical system to print medical and insurance forms and/or receipts and/or prescription. The printer can also print coupons based upon diagnosis to promote product sales. Our software can be included to inform the attendant of low paper in the paper. Video Playback—

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

We claim:

1. A medical system configured to process and provide telehealth services to a patient user, said medical system including a stationary (desk top type computer system, touch pad video screens, etc.) or mobile (i.e. like a computer video gaming console or stationary exercise machine on wheels, smart device, cellular device, etc.) located in an enclosure/space/room/booth having a secure web Cloud/Internet or cellular based 2-way video conferencing system and a plurality of medical devices, said patient user video conferencing system configured for the patient user to have a real-time or near real-time tele-consult with multiple health care provider/s, simultaneously as needed (all which can communicate with the patient and each other in real time), located remotely from said medical system room/space/booth/enclosure (i.e. system), said patient user video conferencing system including a picture in picture (or multiple) video screen/s, camera/s, and microphone/s, said first video screen picture configured to display said medical or mental health care provider during a video conference/consult between said patient user patient and said health care provider, said second video picture screen/s being a touch or mouse controlled screen/s configured for said patient user to provide information regarding said tele-med services, said first and second video picture screen/s and said camera are located in the said system, said plurality of medical devices is configured for use by the patient user/patient to provide information to the health care provider/s about the patient user to enable the health care provider/s to provide real-time or near real-time evidence-based medical or mental health advice to the patient user while the patient user is in a secure private location at the pharmacy or pharmacy supported location, said system includes a plurality of remotely controlled medical biometric monitors that are FDA approved and HIPPA compliant for human patient use and are selectively unlockable by said health care provider and/or patient user.

2. The medical system as defined in claim 1, said plurality of medical devices including two or more biometric monitoring devices selected from the group consisting of, but not limited to, a stethoscope, an otoscope, a thermometer, a derma scope, a spirometer, blood pressure cuff, a pulse oximeter, a heating pad, a magnifying camera, a blood glucometer, an audiometer, and a 3-lead EKG.

3. The medical system as defined in claim 1, wherein at least one said remotely controlled biometric monitors is unlockable/activated as the patient user progresses through a vitals capture program.

4. The medical system as defined in claim 1, wherein including a seat or other body weight scale.

5. The medical system as defined in claim 1, wherein including a speaker system and/or headphone jack.

6. The medical system as defined in claim 1, including a mobile device application or network application, said mobile application or network application configured to provide the patient user access to various functions on a mobile device or computer, said functions in including one or more functions selected from the group consisting of 1) locating an available medical system, 2) scheduling an appointment with the health care provider, 3) pre-registering symptoms for visit, 4) setting an immediate consult with the medical system provider/s, 5) receiving reminders regarding availability of appointments or walk in hours for the medical system, 6) obtaining information about medical system provider/s availability, 7) obtaining information about specialty/lab/support health care provider/s availability, 8) obtaining information about available health care provider/s access, 9) selecting a health care health care provider/s, 10) obtaining map information regarding a selected medical system location, 11) locating the closest system for an immediate, scheduled or walk in appointment with a primary health care provider/s or specialist in a certain field of health care, 12) submitting medical insurance if applicable, 13) submitting payment information, 14) receiving information on payment status, 15) receiving information on insurance coverage, 16) receiving updates regarding appointment regarding appointments for the medical system, 17) receiving prescription and prescription management information, 18) submitting payment information for prescriptions, 19) answering surveys regarding the use of the medical system, 20) receiving medication reminders, 21) registering reasons for visit, 22) canceling an appointment with the medical system, 23) selecting a certain health care provider/s in a certain field of medicine, 24) providing address information regarding a selected medical system, 25) obtaining hours of operation information regarding a selected medical system if not 24 hrs., 26) locating the closest System for an appointment with a primary care health care provider/s, 27) locating the closest system availability for an appointment with a certain health care provider/s in a certain field of medicine if walk in is not available, 28) locating the closest system availability for an appointment or walk in consult with a primary health care provider/s, and 29) preclearing medical insurance if applicable.

7. The medical system as defined in claim 1, including a medication adherence software application configured to provide the patient user and health care provider with HIPPA compliant access to one or more functions selected from the group consisting of 1) speaking to multiple providers simultaneously, coordinated by the primary health care provider including a live or tele pharmacist in real time, 2) changing the patient user's medications alerts, 3) obtaining information about certain types of medical conditions, 4) checking medication orders status, 5) checking medication delivery status, 6) filling and/or refilling prescriptions, 7) transferring prescriptions to a another location, 8) obtaining information about recommended medication dosages, 9) obtaining information about recommended times to take medications, 10) obtaining information about recommended frequency for taking medications, 11) obtaining general or patient user specific information about medications, 12) obtaining information about generic brands available for medications, 13) requesting an appointment to speak with the health care provider/s, 14) entering information regarding compliance information regarding medication usage by patient user, 15) receiving real time compliance reports for patient users regarding medication usage, 16) paying for a prescription, 17) selecting between a generic and non-generic brand of medication, 18) comparing pricing options for medications, 19) providing reminders for patient users to take their medications, 20) monitoring progress and real time reports regarding the patient user's adherence to medication usage, 21) enrolling the patient user in an electronic prescriptions network at the pharmacy located Medical system or pharmacy supported location which electronically forwards their prescription/s to the pharmacist, pharmacy tech or electronic prescription vending station, 22) comparing delivery options for medications, and 23) generating progress reports regarding the patient user's adherence to medication usage.

8. The medical system as defined in claim 1, includes an registration function including a patient user input system that enables the patient user to enter information about the patient user prior to having said real-time or near real-time tele-conference with the primary health care provider (mental health or physical health care provider/s), said patient user input system including one or more components selected from the group consisting of a key/touch pad for identification, a key/touch pad for data entry, key/touch board or reader for physical and/or biometric identification, a microphone and voice recognition software for identification, a microphone and voice recognition software for data entry, a biometric (iris scanner, fingerprint scanner, facial recognition and/or video verification, etc. . . . ) for identification, 2 way video camera/s, speaker/s, card reader, smart device reader/scanner, motion sensor, sound sensor, and temperature sensor, said registration station configured to provide the patient user access to one or more functions selected from the group consisting of a) entering the patient user's name, b) entering the patient user's address, c) entering the patient user's contact information, d) entering the patient user's age, e) entering the patient user's sex, f) entering the patient user's height, g) entering the patient user's weight, h) entering the patient user's race, i) entering the patient user's language, j) entering the patient user's selected medical history, k) entering medication profile and allergies by patient user, l) entering information on past medical condition, m) entering reason(s) for visit by the patient user, n) entering patient user's current symptoms, o) entering patient user's allergies, p) entering patient user's ID information, q) entering patient user's insurance information, r) entering patient user's payment information, s) entering consent and HIPPA compliant information, t) requesting assistance from a medical attendant, u) entering real time and date of the patient user appointment, v) entering patient user's current primary care health care provider/s if applicable, w) requesting a specific type/s of medical or mental health care provider, x) providing information to the patient user about the medical system, y) providing information to the patient user on how to use the web/cloud based medial system, z) providing information to the patient user on how to properly input/convey information to the medical system where needed, aa) providing the patient user information during the inputting/conveying of information by the patient user to the medical system, bb) providing the patient user information on the wait time if applicable for the patient user's use of the medical system, cc) providing the patient user with a number of other patient users waiting to use the medical system, dd) providing the patient user with information regarding whether the medical system care provider/s are in use or when available, ee) entering type of provider/s the patient user desires during the video telehealth appointment, and ff) requesting a medical care provider having a particular medical specialty or level of care required if known.

9. The medical system as defined in claim 1, includes a display screen that can be used to provide one or more types of information (or health care related advertisement) selected from the group consisting of advertising information, information about the medical system, information about wait time for the medical system if applicable, information as to the order of patient users waiting to use the medical system, information about whether a medical system is available or in use, cable TV shows, satellite TV shows, local broadcast TV shows, infomercials, medical programs, DVD materials, Blu-ray materials, video programs, YouTube programs, and pictures, said display configured to only display information and to not accept data entry from the patient user.

10. The medical system as defined in claim 1, said internal enclosure including a cleaning or sanitizing system to clean or sanitize at least a portion of said internal enclosure, said cleaning or sanitizing system including a system selected from the group consisting of a UV system and a mist system.

11. The medical system as defined in claim 1, including a prescription drug system configured to provide the patient user access to one or more functions selected from the group consisting of 1) obtaining generated prescriptions from the health care provider/s, 2) ordering drugs, 3) selecting name brand and generic drugs, 4) selecting the supply quantity for the prescription, 5) the selection method by which the patient user will obtain a prescription 6) entering the patient user medical insurance for partial or full payment of the prescription, 7) entering the patient user's PayPal, credit or debit card information to pay for the prescription, 8) entering the patient user's information for mail/alternate delivery of the immediately unavailable or controlled prescription, 9) providing reminders to the patient user regarding medication refills, 10) providing notifications to the patient user when prescription has been mailed/delivered if applicable, 11) selecting the pharmacy where the patient user would like to pick-up the prescription if applicable or unavailable immediately, 12) providing reminders to the patient user regarding follow-up medical/system visits, and 13) providing notifications to the patient user when prescription is ready at the pharmacy.

12. The medical system as defined in claim 1, including a moveable secure enclosure/panel to allow limited provider/technician access to one or more components located behind the moveable panel located in said secure enclosure, said one or more components including components selected from the group consisting of 1) electronics attached to the keyboard and/or touch screen/s of the system, 2) electronics located behind the PIP (picture in picture) enabled video screen/s and video/digital cameras 3) electronics used for network communication.

13. We claim the medical system method for providing a real-time or near real-time tele-conference with multiple health care providers simultaneously (if necessary as a provider team consult) located remotely from a medical system and a patient user located at the medical system, said method comprising the steps of: a. providing an Internet web/cloud/cellular based medical system, said medical system including a private consult area/room/enclosure/system, etc. . . . , a patient user video conferencing system and a plurality of medical devices, said patient user video conferencing system configured for the patient user to have a real-time or near real-time tele-conference with a multiple health care provider/s simultaneously through Picture in a Picture technology or multiply screens located remotely from said medical system, said patient user video conferencing system including a video screen/s, 2 way camera/s, audio speaker/s and a microphone/s all which can be externally or internally located in the system, with said first video screen/s configured to display said the primary health care provider during a video conference between said patient user and said health care provider/s, said 2 way video system being controlled by a touch screen or key pad configured for said patient user to provide information regarding said tele-med services, said video screen/s and said camera/s are located to capture both patient users and remote health care providers, including said plurality of medical devices as configured for use by the patient user to provide information through the primary health care provider to enable the health care provider/s to provide real-time or near real-time medical advice to the patient user while the patient user is in said private enclosure/room/space/container/booth, said enclosure includes a plurality of remotely controlled medical monitoring devices, each of said remotely controlled medical devices includes at least one of said medical devices, includes a lockable/secure area (physical and/or electronic) that limits access to said at least one medical device in said medical system, b. providing one or more applications selected from the group consisting of an attendant application, an appointment application, a provider application, a schedule application, a patient portal application, medical adherence application, an administrator application, and a provider portal application; said attendant application includes software and/or hardware configured for an remote or onsite attendant to 1) monitor, modify and/or cancel or modify existing appointments for the medical system, 2) monitor whether a patient requires assistance, 3) monitor and/or assist a patient user during registration with the medical system, 4) provide procedures and/or check lists for the attendant, and/or 5) provide information on the status of the medical system, said attendant application configured to provide the attendant access to one or more functions selected from the group consisting of a) displaying one or more appointment fields of a patient user, said appointment fields include one or more fields selected from the group consisting of time of appointment, patient user name, health care provider/s name, status of appointment and action of the attendant, b) checking-in a patient user, c) cancelling and/or rescheduling an appointment, d) entering provider/s electronic notes about a visit, e) entering notes about a canceled and/or rescheduled visit, f) viewing notes from the health care provider/s about a patient user, g) printing a visit summary, h) associating an emergency clean-up with a patient user appointment, i) viewing appointment information, j) validating patient user IDs, k) validating patient user insurance, l) modifying an appointment, m) clean protocols for the medical system, n) selecting patient user records, o) entering BD and/or insurance information, p) providing notice of instructions and/or policies to be given to the patient user, q) updating patient user information, r) entering payment and/or copay information and/or payments for the patient user's visit, s) displaying a list of sanitation protocols and/or procedures, and t) activating automatic sanitation process; said appointment application configured to provide the patient user access to one or more functions selected from the group consisting of 1) identify patient user as a new and/or returning patient user, 2) scheduling a new appointment, verifying a previously confirmed appointment and/or canceling an appointment, 3) welcoming a patient user that has already scheduled an appointment, 4) providing the patient user with a privacy policy associated with the use of the medical system, 5) providing the patient user with terms of service policy associated with the use of the medical system, 6) requesting information as to why the patient user is using the patient user registration system, 7) requesting the patient user to enter a password, phone number, pin number, name, email address, address, date or birth and/or sex to identify the patient user, 8) requesting the patient user to verify if the patient user is at least a certain age, 9) requesting the patient user to identify one or more symptoms that the patient user is experiencing in which the patient user is seeking medical assistance, 10) requesting the patient user to answer one or more follow-up questions after the patient user enters the one or more symptoms, 11) informing the patient user to seek an in-person visit by the health care provider/s after the patient user has identified one or more symptoms that the patient user is experiencing, 12) requesting the patient user to identify one or more known allergies of the patient user, 13) requesting the patient user to identify one or more known medical conditions of the patient user, 14) requesting the patient user to identify one or more past medical procedures that have been performed on the patient user, 15) requesting the patient user to identify one or more medications the patient user is taking, 16) asking the patient user if the patient user has medical insurance, 17) requesting the patient user to enter in the medical insurance information and/or to scan the insurance card, 18) requesting the patient user to make a copay based the medical insurance or to fully pay for the medical visit, 19) enabling the patient user to request assistance, 20) listing one or more days and/or times that the medical system is available for use by the patient user, 21) verifying all of the required information and payment information has been made by the patient user by displaying information on a screen, printing out verification for the patient user, emailing verification to patient user, texting verification to the patient user and/or leaving a voicemail of verification for the patient user, 22) updating patient user information, 23) storing information in a patient user file, 24) navigating the patient user through the vitals capture process, 25) navigating the patient user through the patient user consultation, and 26) navigating the patient user through a survey; said provider application is configured to have one or more features selected from the group consisting of a) displaying appointment information, b) displaying patient user information, c) viewing and/or modifying visit information, d) performing a consultation with the patient user, and e) accessing information from one or more medical devices in the medical system, said provider application configured to provide the health care provider/s access to one or more functions selected from the group consisting of 1) viewing appointments that have been completed by the health care provider/s or are in progress for a certain day, 2) viewing appointments that have been made for a future time, 3) displaying one or more types of patient user appointment information, said patient user appointment information including information selected from the group consisting of time of appointment, patient user names, status of appointment, patient user payment status, patient user checked-in status, vitals collection status, status of video consultation status of data entry by the health care provider/s regarding video consultation, and status of appointment, 4) displaying a record about a patient user, such record information selected from the group consisting of patient user name, patient user date of birth, patient user sex, patient user symptoms, patient user medical conditions, date of last visit, diagnosis, allergies, medications, prior visit record of patient user, and medical records of patient user, 5) notifying the attendant that the patient user requires assistance, 6) limiting access to a patient user's information, 7) refusing an appointment that has been created for the health care provider/s, 8) beginning the conference with the patient user once the patient user is ready in the medical system, 9) viewing the patient user on the health care provider/s's screen, 10) ending the consultation with the patient user, 11) viewing the patient user records, including the vitals capture process that has occurred or is occurring in the medical system, 12) modifying a patient user's record, 13) adding and/or removing medication, medical conditions, allergies and/or symptoms information in the patient user's record, 14) entering notes about a patient user, diagnoses for a patient user, and/or follow-up care for a patient user, 15) controlling access to and/or activate one or more medical devices in the medical system, 16) viewing the results from the use of one or more medical devices that have been used by the patient user, 17) creating a visit summary for a patient user, 18) creating a prescription for a patient user, 19) providing one or more visit documents and/or other types of documents to the patient user, 20) contacting another health care provider/s on the provider screen and/or enable the other health care provider/s to be viewed by the patient user, 21) engaging a translator to facilitate communication between the patient user and health care provider/s, and 22) contacting a third party to obtain information about and/or authorization for a patient user using the medical system; said scheduling application includes one or more functions selected from the group consisting of 1) enabling a patient user or primary care provider to select a particular health care provider/s/s in real time 2) making an appointment on a medical system at a particular time and place or immediate video consult with multiple providers, 3) enabling a patient user to select the health care provider/s or type of health care provider/s based on the particular need of the patient user, 4) locating available locations of medical systems, 5) enabling a patient user to enter information about the patient user, 6) checking past, current and/or future appointments of the patient user regarding use of the medical systems, 7) entering a partial or full payment for use of the medical system, 8) entering medical insurance information, 9) making payment information, 10) enabling a patient user to request assistance, 11) enabling a patient user to enter consents and/or consent forms, and 12) enabling the patient user to receive reminders about the appointment; said patient portal application configured to provide the health care provider/s access to one or more functions selected from the group consisting of 1) locating an available medical system, 2) scheduling an appointment with the medical system, 3) pre-registering symptoms and/or reasons for visit, 4) setting and/or canceling an appointment with the medical system, 5) receiving reminders and/or updates regarding appointments for the medical system, 6) obtaining information about medical systems availability, 7) obtaining information about certain health care provider/s availability, 8) obtaining information about the available health care provider/s, 9) selecting a certain health care provider/s and/or health care provider/s in a certain field of medicine, 10) obtaining map information, address information and/or hours of operation information regarding a selected medical system, 11) locating the closest system and/or system availability for a certain health care provider/s/s and/or health care provider/s/s in a certain field of medicine, 12) pre submitting and/or preclearing medical insurance, 13) submitting payment information, 14) receiving information on payment status, 15) receiving information on insurance coverage, 16) receiving appointment reminders and/or updates, 17) receiving prescription information, 18) submitting payment information for medical visit and/or prescription, 19) answering surveys regarding the use of the medical system, and 20) receiving medication reminders; said medical adherence application is configured to assist patient user with regard to medications, said medical adherence application including one or more functions selected from the group consisting of 1) reminding patient users to take their meds, 2) automatically creating a log when the patient user takes their medication, 3) tracking a patient user's compliance to taking their medication on time, 4) providing automatic progress reports, 4) real time referring the patient user through the primary care provider to an onsite or tele pharmacist to answer any questions and/or for additional consultation, 5) automatically enrolling the patient user in a e-script network or electronic dispenser, which network sends their prescriptions to the pharmacy of their choice or adjacent dispenser, 6) assisting in improving patient user satisfaction regarding medication compliance, 7) accessible on a screen in the medical system, and/or on a computer screen and/or mobile device, 8) allowing a patient user to speak to a pharmacist, 9) allowing a patient user to change medication alerts 9) providing information to a patient user about various medical condition, 10) allowing the patient user to check medication order status, 11) allowing the patient user to refill prescriptions, 12) allowing patient user to transfer prescriptions to a pharmacy, 13) providing patient user with information about recommended dosages of medication, 14) providing information to patient user regarding period for taking medications, 15) providing patient user with information regarding frequency for taking medications, 16) providing information to patient user regarding information about medications, 17) providing information to patient user regarding generic brands available for medications, 18) allowing a patient user to request an appointment to speak with the health care provider/s, 19) allowing the patient user to enter compliance information regarding medication usage by patient user, 20) providing patient user with medication alerts, 21) allowing the patient user to change medication alerts, 22) allowing the patient user to select how information will be sent to patient user, and 23) providing the patient user with medication guidelines and/or medical plans; said an administrator application configured so that a medical administrator can remotely access one or more components of the medical system; said administrator application including one or more functions selected from the group consisting of 1) allowing remote access to one or more medical devices in the medical system, 2) allowing remote access to one or more computers in the medical system, 3) allowing remote access to one or more routers in the medical system, 4) allowing remote access to one or more displays on the medical system, 5) allowing diagnostics to be executed from a remote location on one or more electronic components in the medical system, 6) allowing the rebooting and/or reinitializing from a remote location of one or more electronic components in the medical system, 7) allowing for review of the current and/or past status from a remote location of one or more electronic components in the medical system, 8) allowing remote access to one or more power supplies in the medical system, 9) allowing remote access to one or more servers in the medical system, 10) allowing remote access to one or more drives and/or cloud storage systems in the medical system, 11) allowing hardware and/or software updates to be remotely sent and/or loaded onto one or more electronic components in the medical system, and 12) allowing software to be loaded onto and/or removed from one or more electronic components in the medical system; said provider portal application configured to provide the health care provider/s access to one or more functions selected from the group consisting of 1) accessing another health care provider/s, 2) enabling two or more health care provider/s to be simultaneously viewed and/or heard by the patient user in the medical system, 3) enabling the health care provider/s to switch to a new health care provider/s such that only the new health care provider/s is not viewed by the patient user in the medical system, and 4) allowing a second health care provider/s to listen and/or communicate with the patient user in the medical system.

14. The method as defined in claim 13, said plurality of biometric medical devices including two or more devices selected from the group but not limited to consisting of a stethoscope, an otoscope, a thermometer, a derma scope/magnifying camera, a spirometer, blood pressure cuff, a pulse oximeter, a heating pad, a magnifying glass, a tongue depressor, tweezers, a blood glucometer, an audiometer, and a 3-lead EKG.

15. The method as defined in claim 13, wherein at least one said remotely controlled biometric medical device is unlockable (electronically or physically) as the patient user progresses through a vitals capture program, and including the further step of causing said at least one remotely controlled medical devices to unlock as the patient user progresses through a certain portion of the vitals capture program.

16. The method as defined in claim 13, wherein said medical system includes an integrated body weight scale.

17. The method as defined in claim 13, wherein said medical system includes a headphone jack.

18. The method as defined in claim 13, including a mobile device application or network application, said mobile application or network application configured to provide the patient user access to various functions on a mobile device or computer, said functions in including one or more functions selected from the group consisting of but not limited to 1) locating an available medical system, 2) scheduling an appointment with the medical system, 3) pre-registering symptoms for visit, 4) setting an appointment with the medical system, 5) receiving reminders regarding appointments for the medical system or walk in hours, 6) obtaining information about medical system availability, 7) obtaining information about certain health care provider/s/s availability, 8) obtaining information about available health care provider/s, 9) selecting a certain health care provider/s, 10) obtaining map information regarding a selected medical system, 11) locating the closest system for an appointment with a certain health care provider/s in a certain field of medicine, 12) pre submitting medical insurance, 13) submitting payment information, 14) receiving information on payment status, 15) receiving information on insurance coverage, 16) receiving updates regarding appointment regarding appointments for the medical system, 17) receiving prescription information, 18) submitting payment information for prescriptions, 19) answering surveys regarding the use of the medical system, 20) receiving medication reminders, 21) pre-registering reasons for visit, 22) canceling an appointment with the medical system, 23) selecting a certain health care provider/s in a certain field of medicine, 24) providing address information regarding a selected medical system, 25) obtaining hours of operation information regarding a selected medical system, 26) locating the closest system for an appointment with a certain health care provider/s, 27) locating the closest system availability for an appointment with a certain health care provider/s in a certain field of medicine, 28) locating the closest system availability for an appointment with a certain health care provider/s, and 29) preclearing medical insurance.

19. The method as defined in claim 13, wherein said medical system includes a registration station including a patient user input system that enables the patient user to enter information about the patient user prior to having said real-time or near real-time tele-/consult with the health care provider/s/s, said patient user input system including one or more components selected from the group consisting of but not limited to a key pad for identification, a key pad for data entry, key board for identification, a key board for data entry, a touch screen for identification, a touch screen for data entry, a microphone and voice recognition software for identification, a microphone and voice recognition software for data entry, a fingerprint scanner for identification a fingerprint scanner for data entry, a retina scanner for identification, a retina scanner for data entry, camera, speaker, card reader, smart device reader/scanner, motion sensor, sound sensor, and temperature sensor, said registration station configured to provide the patient user access to one or more functions selected from the group consisting of a) entering the patient user's name, b) entering the patient user's address, c) entering the patient user's contact information, d) entering the patient user's age, e) entering the patient user's sex, f) entering the patient user's height, g) entering the patient user's weight, h) entering the patient user's race, i) entering the patient user's language, j) entering the patient user's medical history, k) entering medicines used by patient user, l) entering information on past medical condition, m) entering reason(s) for visit by the patient user, n) entering patient user's current symptoms, o) entering patient user's allergies, p) entering patient user's ID information, q) entering patient user's insurance information, r) entering patient user's payment information, s) entering consent information, t) requesting assistance from a medical attendant, u) entering date the patient user desires an appointment, v) entering patient user's current health care provider/s, w) requesting a specific health care provider/s/s x) providing information to the patient user about the medical system, y) providing information to the patient user on how to use the medial system, z) providing information to the patient user on how to properly input/convey information to the medical system, aa) providing the patient user information during the inputting/conveying of information by the patient user to the medical system, bb) providing the patient user information on the wait time for the patient user's use of the medical system, cc) providing the patient user with a number of other patient users waiting to use the medical system, dd) providing the patient user with information regarding whether the medical system is in use or is available, ee) entering time the patient user desires an appointment, and ff) requesting a health care provider/s/s through the primary care provider online having a particular medical specialty.

20. The method as defined in claim 13, wherein said medical system includes a includes a display screen located external to said internal enclosure that can be used to provide one or more types of information selected from the group consisting of advertising information, information about the medical system, information about wait time for the medical system, information as to the order of patient users waiting to use the medical system, information about whether a medical system is available or in use, medically related advertisement or educational cable TV shows, satellite TV shows, local broadcast TV shows, infomercials, medical programs, DVD materials, Blu-ray materials, video programs, YouTube programs, and pictures, said display configured to only display information and to not accept data entry from the patient user.

21. The method as defined in claim 13, wherein said internal enclosure of said medical system includes a cleaning or sanitizing system to clean or sanitize at least a portion of said internal enclosure, said cleaning or sanitizing system including a system selected from the group consisting of but not limited to a UV light system, a disinfectant mist system and/or antibacterial/anti pathogenic surfaces.

22. The method as defined in claim 13, wherein said medical system includes a moveable panel or electronic software program lock to allow access to one or more components located adjacent to the said video conference screen/s, said one or more components including components selected from the group consisting but not limited to of 1) biometric medical monitoring devices located in the system, 2) electronics located behind or below the video screen/s and 3) electronics used for network communication.
